(19) United States
(12) Patent Application Publication
(10) Pub. No.: US 2019/0139000 A1
(43) Pub. Date: May 9, 2019

(54) SYSTEM AND METHOD FOR FACILITATING ON-DEMAND RECRUITMENT, HIRING AND STAFFING

(71) Applicant: Stacey Elaine Sharpe, Henderson, NV (US)

(72) Inventor: Stacey Elaine Sharpe, Henderson, NV (US)

(21) Appl. No.: 16/122,808

(22) Filed: Sep. 5, 2018

Related U.S. Application Data
(60) Provisional application No. 62/583,395, filed on Nov. 8, 2017.

(51) Int. Cl. G06Q 10/10; G06Q 10/06

(52) U.S. Cl. CPC G06Q 10/1053; G06Q 10/1091; G06Q 10/06393

(57) ABSTRACT

A method and system for enabling at least one transactional service between a plurality of transacting parties comprises at least one communication device, a user interface and a transactional service system. The user interface is configured to the at least one communication device receives a plurality of user inputs that initiates the at least one transactional service. The transactional service system is in communication with the at least one communication device via a network. The transactional service system includes a transactional service server residing on a central computer having installed on a processor with a transactional service application and coupled with a memory unit integrated with a central database. The transactional service system in which one or more transactions involving the recruitment, hiring, employment and retention of workers by an employer directly with an employee or with an intermediary agent are executed.

### BACKGROUND OF THE DISCLOSURE

### Technical Field of the Disclosure

The present disclosure relates generally to systems and methods for facilitating recruitment, hiring and retention of employees and temporary workers and more specifically, to an “On-Demand” hiring platform for employers and employees, combining the resources and services of traditional brick and mortar staffing agencies, resume/job posting websites, and social media markets.

The System and method of the invention offers already vetted candidates along with a video presentation for On-Demand hiring for temporary, temp-perm and permanent job opportunities/assignments. The System and method of the invention offers Employers a proprietary spinning carousel, which allows them to view the candidates completed background check, completed skill-sets, references, star rating, highlights, credentials, and video etc., giving them a quick birds eye view for instantaneous hire, along with the option to drill down into the candidate's full profile.

The system and method of the invention allows employees to be instantaneously alerted of temporary, temp-perm and permanent opportunities/assignments via any mobile device and/or pc, laptop, Mac and any and all electronic devices to show up for work immediately.

### Description of the Related Art

Traditional personnel staffing agencies and Internet recruiting job boards are two entities trying to satisfy the employers' and the employees' needs, and they are not completely succeeding. The failure is due to gaps in both systems traditional staffing and Internet recruiting websites. The gaps exist because the two systems often duplicate each other's activities, and both are plagued by cumbersome, expensive, ineffective processes. Traditional personnel staffing agencies work as intermediaries by helping employers accurately describe job openings and screening candidates who submit applications.

Another trend is the growth of Internet resume/job posting websites and social media sites, these sites also generate exorbitant fees incurred to both the candidate seeking and the employer. It is an interesting fact that these industries are heavily linked because traditional staffing firms and recruiters of companies rely profoundly on these sites to market job availability and to search for candidates to fill their employment needs. Staffing agencies that utilize these sites simply serve as middlemen, and are greatly dependent on these sites to keep their businesses afloat and stay competitive. However, these Internet recruiting sites also rely heavily on the exorbitant amount of fees collected from staffing agencies and companies to have access to their sites.

Many would agree that Internet resume/job posting websites and social media sites have become indispensible to both the corporate world and to the staffing world. While helpful, the process and the cost of using multiple vendors has become time-consuming and very costly, not to mention that the information the sites provide on candidates are oftentimes limited, and both are duplicating efforts. After exhausting a substantial amount of time searching, recruiting, and interviewing, companies are now faced with having to pre-screen, background check, reference check and skill set test these potential hires. They are spending additional billions to other outside vendors that specialize in these functions, as well as their own in-house recruiters and HR staff to complete the process. During this process, production levels are being compromised, companies are getting further behind on time sensitive deadlines and they are working with skeleton crews, thus jeopardizing customer satisfaction, which creates substantial revenue loss on top of the dollars already spent. With the excessive amount of spending billions of dollars to multiple venues who perform identical functions, companies everywhere are looking for ways to streamline costs, so they can maintain staffing levels and continue to hire as demand permits. They are in desperate need to find a one source solution to minimize their losses and keep their doors open.

Furthermore, job seekers have to also rely on several middlemen to find employment; utilizing the same resources, and once again, efforts are being duplicated. These job seekers are spending an enormous amount of their time on these searches, as well as excessive consumption from paper to fuel to find employment. Yet, the end results are often disappointing. Job seekers are registering with multiple staffing agencies and often times being presented many times to the same company. In other cases, they are not being afforded an equal opportunity. This is due to the employment agency's internal competitiveness amongst the agency's sales associates. Most traditional staffing agencies operate on a performance-based, sales-driven environment, and they are focused on competing with their sister offices or internal co-workers and are not focusing on the job seekers' needs. These internal agency policies place the candidates in the middle of a commission war, rather than giving the candidate a fair opportunity to apply and interview for all of the positions the agency has to offer. To add to the job seekers' and employers' frustrations, they are both often hurt by the flaws in the search engines within the job boards and resume posting sites. Oftentimes, potential employers receive job alerts or resumes that do not match or meet the required job skill-sets or pre-qualifications. Staffing agencies are also experiencing the same flaws in these systems. Many end up using every available resource, and yet still, the results are bleak. Job seekers are becoming very discouraged and frustrated.

Therefore, there is a need for a system and method for facilitating On-Demand hiring as such a system and method would eliminate the inefficiencies that currently exist today. The present invention overcomes the existing shortcomings in this area by accomplishing these critical objectives.

### SUMMARY OF THE DISCLOSURE

To minimize and address the critical limitations found in the existing systems and methods, and to minimize other limitations that will be apparent upon the reading of this specification, the preferred embodiment of the present invention provides a method and system for enabling at least one transactional service between a plurality of transacting parties. The system comprises at least one communication device, a user interface and a transactional service system. The user interface, configured to the at least one communication device receives a plurality of user inputs that initiates the at least one transactional service. The transactional service system is in communication with the at least one communication device via a network. The transactional service system includes a transactional service server residing on a central computer having a processor installed with a transactional service application and coupled with a memory unit integrated with a central database.

The transactional service application comprises a plurality of programmatic modules. The programmatic module comprises a home page, a welcome module, a log-in module, a registration module, an identification module, a profile build module, a skill-set testing module, 3^{rd} party background check and ride share integration module, a video upload module, a dashboard module, a job requisition module, an analyzing module, a timecard module, a reporting module, a user authorization module, a proprietary spinning carousel, and an alert/notification sending module. The registration module is configured to enable a user to register in the transactional service application utilizing the at least one communication device. The identification module identifies the user whether an employee or an employer. The welcome module enables the user to create a user profile by providing the plurality of user inputs. The analyzing module analyzes the plurality of user inputs stored in the central database of the transactional service application. The analyzing module further comprises a recruitment management module, a hiring establishment module, an employment module and a retention determination module. Furthermore, the timecard module allows the employee to maintain a weekly timecard to reflect an accurate number of working hours and allows the employee to receive an electronic approval from an authorized employer/department head to receive their payroll on-time. The timecard module also allows an employer and/or authorized department head to review, approve or reject an employee's timecard along with a messaging option, star rating option when an assignment is completed or converted through the system and method of the invention. The reporting module provides employer management with statistical data and information on their staffing & hiring trends. The user authorization module that authorizes the user whether to execute the at least one transactional service or pass on the at least one transactional service. Finally, the alert notification sending module which electronically sends a notification upon a successful execution of the at least one transactional service.

In a preferred embodiment, the system and method is provided for enabling all matters relating to the employment, such as compensation, timing, travel arrangements, training, development and human resource services. In some embodiments, the system selects the one or more potential transacting parties based on a determination that these one or more parties are the most likely to be willing to execute the transaction, with the determination process being based on the inputted data. Upon parties agreeing to execute the at least one transactional service, further communications may be sent between the transacting parties. Once either of the parties pass on executing the at least one transactional service, that party is placed back into the public view (proprietary spinning carousel) and a new party from the hierarchy (proprietary spinning carousel) will replace the party who passed on the execution of the transactional service. The system creates a technological platform that allows employee candidates to be matched and hired with potential employers at a click of a button. The benefits of the system and method of the invention include a wide range of services available to employers and candidates. The System and method of the invention offers already vetted employee/candidates along with a video presentation for On-Demand hiring for temporary, temp-perm and permanent job opportunities/assignments. The System and method of the invention offers employers a proprietary spinning carousel, which allows them to view the candidates completed background check, completed skill-sets, references, star rating, highlights, credentials, and video etc., giving them a quick birds eye view for instantaneous hire, along with the option to drill down into the candidate's full profile. The system and method of the invention allows employees to be instantaneously alerted of temporary, temp-perm and permanent opportunities/assignments via any mobile device and/or pc, laptop, Mac and any and all electronic devices to show up for work immediately.

The system and method of the invention is a singular source for all employment needs, cutting out the middlemen and the significant amount of fees that are associated to utilize these now separate venues that perform identical functions. Candidates have a competitive edge over the competition, namely because the profile system, video presentation and their backgrounds and skill-sets are already completed, which provides a complete picture of who they are and what they have to offer. Companies will be able to save on their staffing budgets and have the comfort of utilizing one solution, a “One Stop Shop” without the hassle of contacting multiple resources. Employers no longer have to hire several employment agencies, perform background checks, utilize multiple job boards and resume posting websites, or partner with vendor management systems to manage and give reporting on their contingent workforce. With a click of a button, a company can hire and pay for their staff on-line. They have options of paying via an established account set-up, ACH wire transfer/bank draft or Visa/MC payment directly on-line. They can hire at a moment's notice to have the employee show-up for work immediately. Job seekers can be alerted by email and/or SMS text messaging of temporary, temp-perm job assignments and/or permanent full-time opportunities that meet their specific skill-sets and job requirements, they can be dispatched out to the physical job assignment utilizing a provided map, along with all of the details, report to person and instructions of the job assignment. They have the ability to record their working hours on-line via the timecard module and receive their pay on-line via direct deposit, “JobDogg” Visa/MC pay-card or option to have a paper check mailed.

A first objective of the present invention is to provide a method and system for enabling at least one transactional service between a plurality of transacting parties.

A second objective of the present invention is to provide a method and system for creating a technological platform that allows employee candidates to be matched with potential employers instantaneously.

A third objective of the present invention is to provide a method and system that renders a business with the capability to provide a means to enable transactional services relating to employment.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not shown in order to provide a clear view of the various embodiments of the invention, thus the drawings are generalized in form in the interest of clarity and conciseness.

FIG. 1 illustrates a high-level block diagram of a system for enabling at least one transactional service between a plurality of transacting parties in accordance with the preferred embodiment of the present invention;

FIGS. 2A-2C illustrate a flowchart of a method for enabling at least one transactional service between a plurality of transacting parties in accordance with the preferred embodiment of the present invention; and

FIGS. 3-50 illustrate screenshots of web pages of a transactional service software application of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

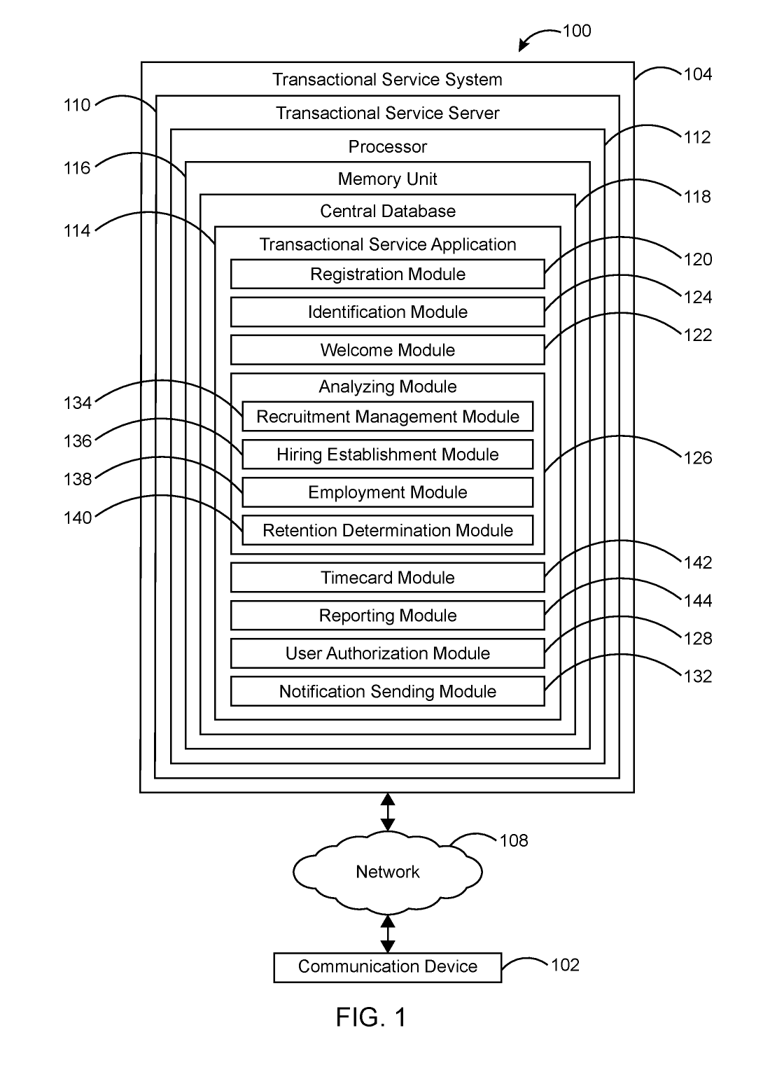

Turning first to FIG. 1, a block diagram of a system 100 for enabling at least one transactional service between a plurality of transacting parties in accordance with the preferred embodiment of the present invention is illustrated. The system 100 comprises at least one communication device 102 and a transactional service system 104. The transactional service system 104 being in communication with the at least one communication device 102 via a network 108, the transactional service system 104 including a transactional service server 110 residing on a central computer having a processor 112 installed with a transactional service application 114 and coupled with a memory unit 116 integrated with a central database 118. The transactional service application 114 comprises a plurality of programmatic module. The programmatic module comprises a registration module 120, an identification module 124, a welcome module 122, an analyzing module 126, a timecard module 142, a reporting module 144, a user authorization module 128 and a notification sending module 132.

The registration module 120 is configured to enable a user to register in the transactional service application 114 utilizing the at least one communication device 102. The identification module 124 identifies the user whether the user is an employee or an employer. The welcome module 122 enables the user to create a user profile by providing the plurality of user inputs. The analyzing module 126 analyzes the plurality of user inputs stored in the central database 118 of the transactional service application 114. The analyzing module 126 further comprises a recruitment management module 134, a hiring establishment module 136, an employment module 138 and a retention determination module 140. The recruitment management module 134 is designed to manage at least one recruiting process by the employer through the at least one communication device 102. The hiring establishment module 136 is configured to evaluate and integrate at least one hire by the employer. The employment module 138 maintains a plurality of employment activities by the employee and the retention determination module 140 monitors performance rating by the employee through the at least one communication device 102. Further, the timecard module 142 allows the employee to maintain a timecard to reflect an accurate number of working hours. The timecard module 142 also allows an authorized department head to review and approve or reject the employee timecard so that an employee can be paid on a weekly basis and is also used as a messaging tool when converting or completing a temporary or temp-perm assignment. The reporting module 144 allows the employer to view, download and print their hiring and staffing trends. The reporting module 144 also provides employer management with statistical information on current and past employees that are in the system database. The user authorization module 128 authorizes the user whether to execute the at least one transactional service or pass on the at least one transactional service. Finally, the notification sending module 132 which electronically sends a notification upon a successful execution of the at least one transactional service.

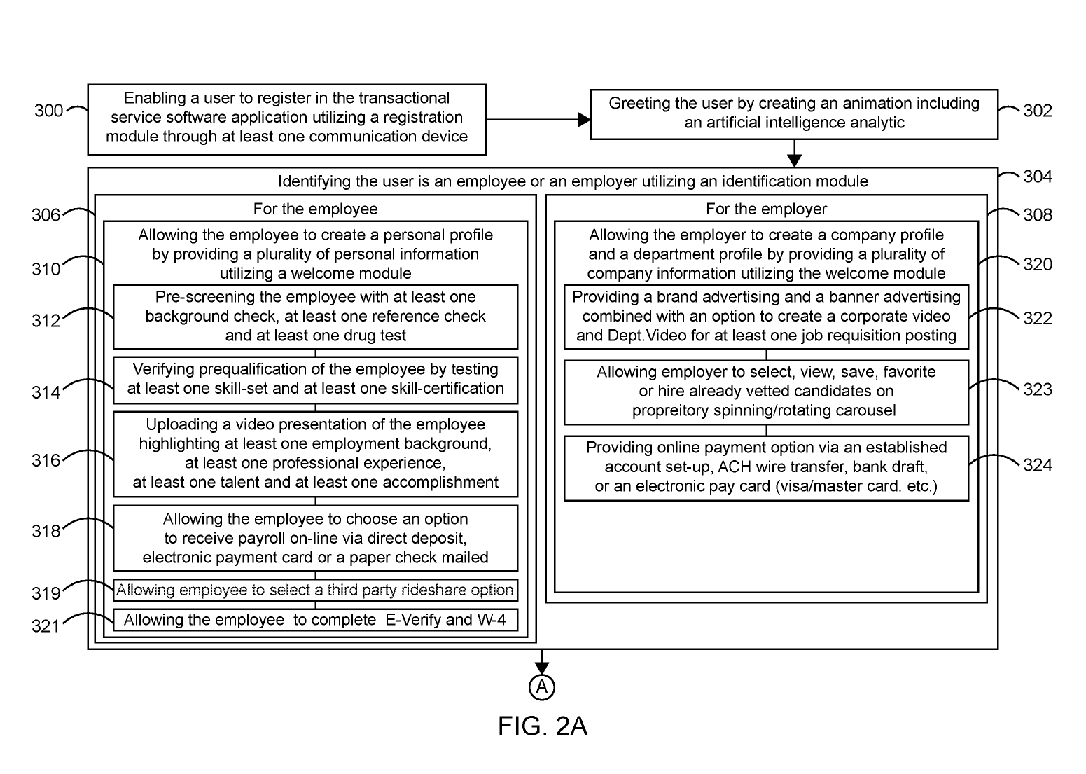

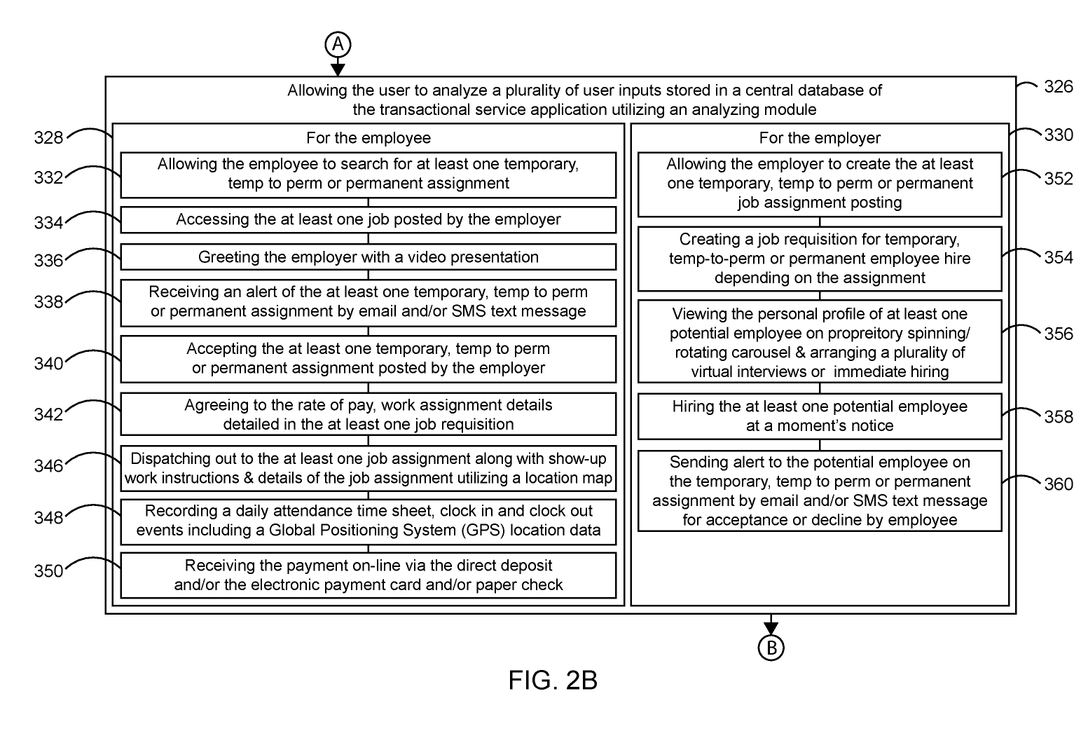

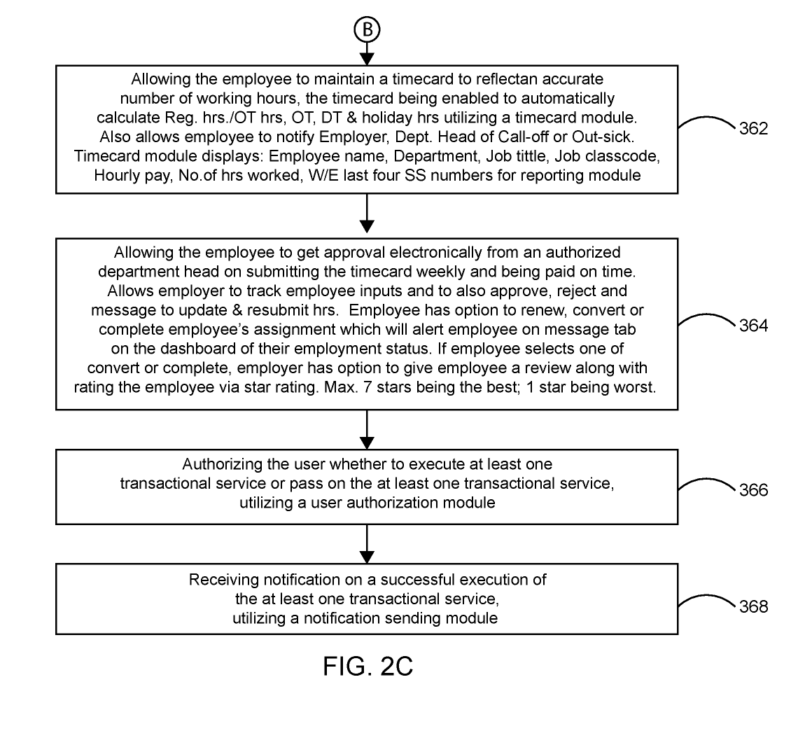

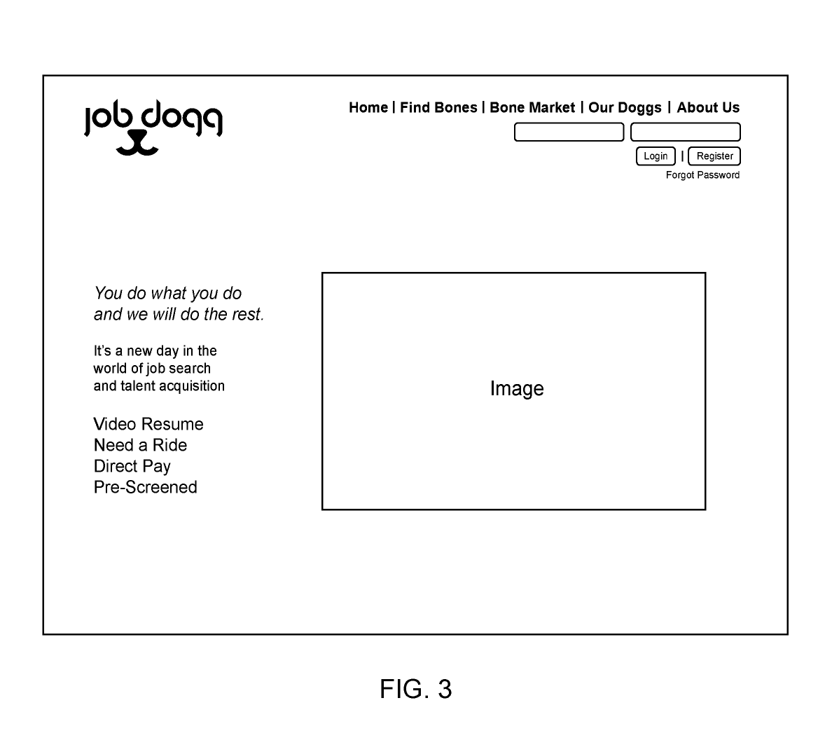

FIGS. 2A-2C illustrates an operational flowchart of a method for enabling the at least one transactional service between the plurality of transacting parties in accordance with the preferred embodiment of the present invention. The method disclosed herein provides the transactional service system 100 of FIG. 1 in communication with the at least one communication device via the network. The method starts by enabling the user to register in the transactional service software application utilizing the registration module through at least one communication device as indicated at block 300. Next, the user is greeted by an animation including an artificial intelligence analytic as indicated at block 302. Then, identifying the user, whether the user is an employee or an employer by utilizing an identification module as indicated at block 304. If the user is identified as an employee, then allows the employee to create a personal profile by providing a plurality of personal information utilizing a welcome module as shown in blocks 306 and 310. The plurality of personal information required to create the personal profile is illustrated in blocks 312, 314, 316 and 318. The profile creation for the employee is initiated by pre-screening the employee with at least one background check, at least one reference check and at least one drug test as shown in block 312. Then, verifying prequalification of the employee by testing at least one skill-set and at least one skill-certification as shown in block 314. Next, uploading a video presentation of the employee highlighting at least one employment background, at least one professional experience, at least one talent and at least one accomplishment as shown in block 316. The profile creation is completed when the employee candidate selects the preferred method for receiving payroll payment options. The options include direct deposit, electronic pay cards, and paper checks by the employee as shown in block 318. Finally, the employee is allowed to select a rideshare option Uber/Lyft as shown in transportation block 319. If the user is registering as an employer, then allows the employer to create a company profile and/or a department profile by providing a plurality of company information utilizing the welcome module as indicated at blocks 308 and 320. The plurality of company information required is illustrated in blocks 322 and 324. The employer is enabled to select, view, save, favorite or hire already vetted candidates on proprietary spinning/rotating carousel as shown in block 323. The company profile creation for the employer includes providing a brand advertising and a banner advertising combined with an option to create a corporate video and a department video and at least one job requisition/posting by the employer as shown in block 322 and providing a payment option for payment of annual membership dues as well as mark-up fees/rates on the salary offered upon hiring a temporary or temp-perm employee and a percentage/flat fee for permanent hires. Employees have the option of paying via an established account set-up, ACH wire transfer/bank draft, or a Visa/MC payment directly on-line to as shown in block 324.

Further in block 326, the analyzing module allows the user to analyze the plurality of user inputs stored in the central database of the transactional service application. If the user is the employee, then allows the employee to search and apply for at least one temporary, temp to perm or permanent assignment utilizing the employment module as shown in blocks 328 and 332. Then accessing the at least one job posted by the employer as shown in block 334. Next, greeting the employer with a video presentation as shown in block 336. Then, receiving an alert of the at least one temporary, temp-perm or permanent assignment by email and/or SMS text message as shown in block 338 and accepting the at least one temporary, temp to perm or permanent assignment posted by the employer as shown in block 340. Then, agreeing to the rate of pay and work assignment/duties detailed in the at least one job requisition/posting as shown in block 342 and dispatching out to the at least one job assignment along with show-up to work instructions/details of the job assignment utilizing a location map as shown in block 346. Next, recording a daily attendance time sheet, clock in and clock out events including a Global Positioning System (GPS) location data utilizing the retention determination module as shown in block 348. Finally, receiving the payment on-line via direct deposit, Visa/MC pay-card, or paper check as shown in block 350. If the user is the employer, then allows the employer to create the at least one temporary, temp to perm or permanent job assignment posting utilizing recruitment management module as shown in blocks 330 and 352. Next, building company profile providing company information and benefits of working for the employer including an option to create a corporate and a department video as shown in block 354. Then, creating a job requisition/posting for temporary, temp-to-perm or permanent employee hiring. 355. Next, viewing the personal profile of at least one potential employee on the proprietary spinning/rotating carousel, and arranging a plurality of virtual interviews or immediate hiring as shown in block 356. Finally, hiring the at least one potential employee at a moment's notice utilizing the hiring establishment module and sending alert to the potential employee on the temporary, temp to perm or permanent assignment by email and/or SMS text messaging for acceptance or decline by the employee as shown in blocks 358 and 360.

Further in block 362, the timecard module allows the employee to maintain the timecard to reflect the accurate number of working hours, the timecard being enabled to automatically calculate Reg. hrs., OT hrs., DT and Holiday hours as defined by the employer. At block 364, the timecard module also allows the employee to notify employer/department head of call-off, out sick or no show through timecard messaging module. Timecard module displays: employee name, job title, department, job classification code, hourly pay, real time hours worked to date, payroll week-ending date, and last 4 of the social security number for the reporting module. At the end of each year all candidates that have been on assignment through the Applicant's system will receive a W-2 for tax purposes, which can also be found on the employees' dashboard and of which they will also be notified via email and/or SMS text messaging of the W2 availability. Timecard module allows the employee to get approval electronically from the employer/authorized department head when submitting their timecard weekly.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams can be implemented by computer readable program instructions.

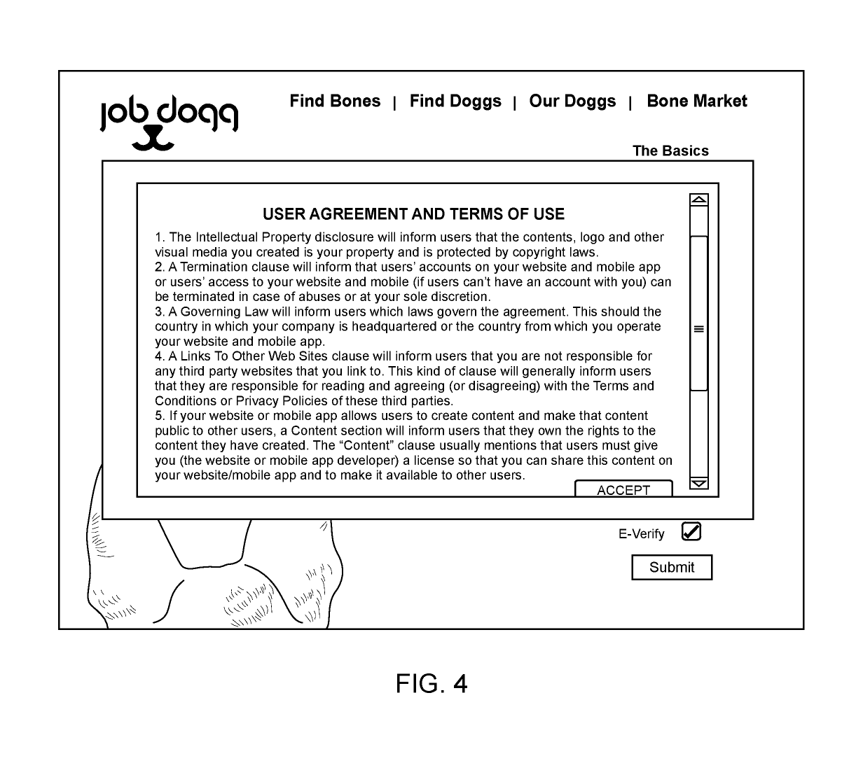

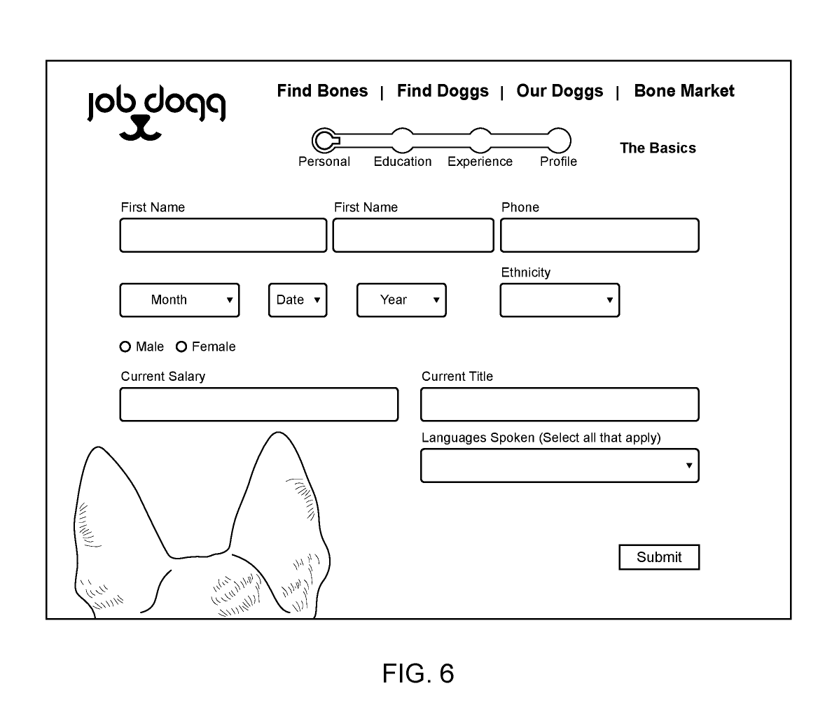

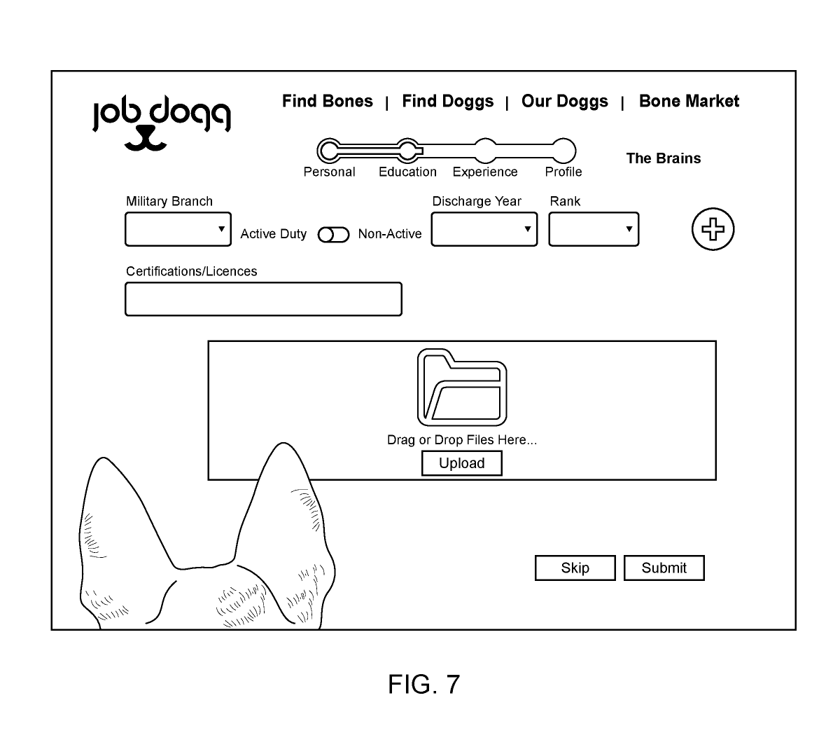

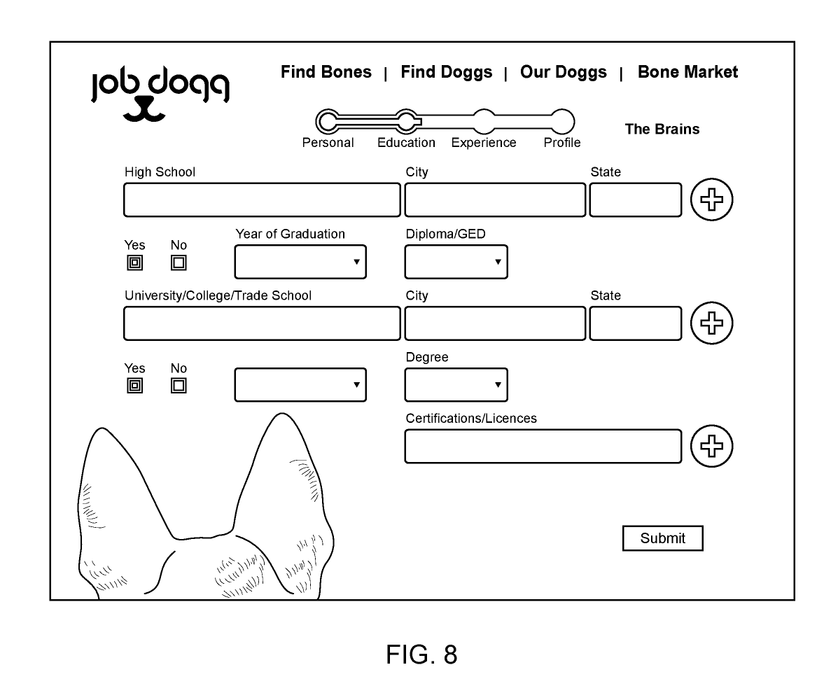

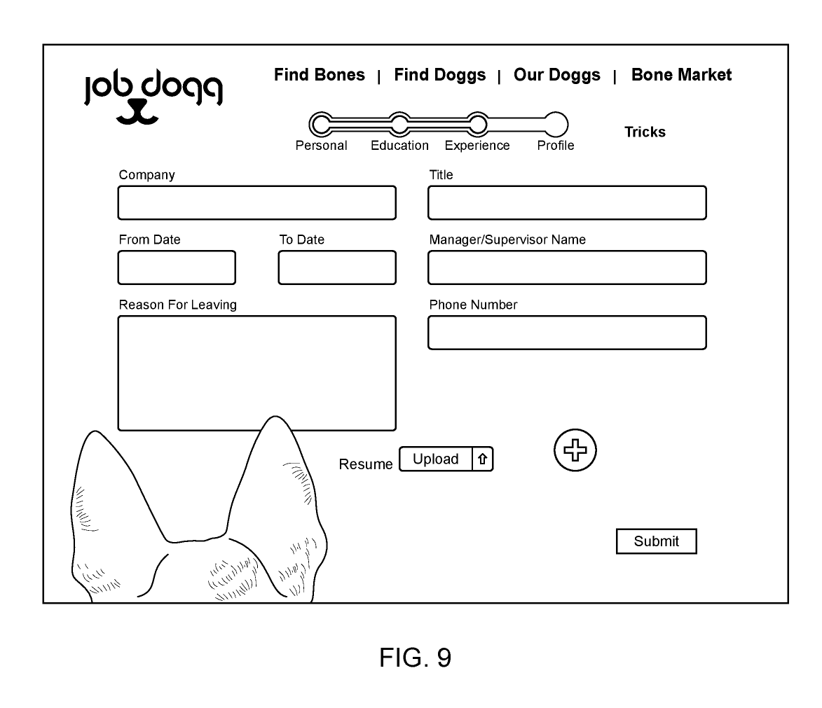

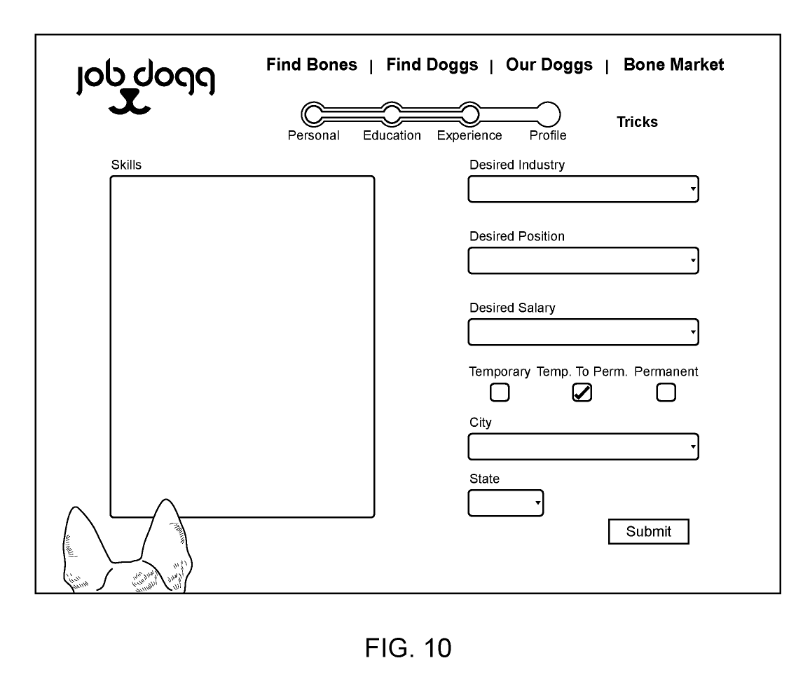

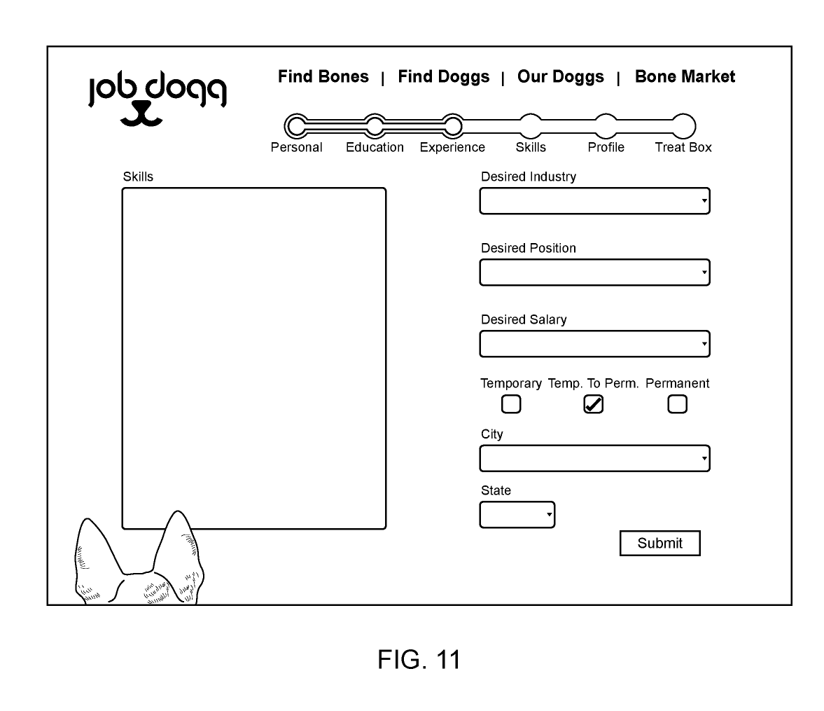

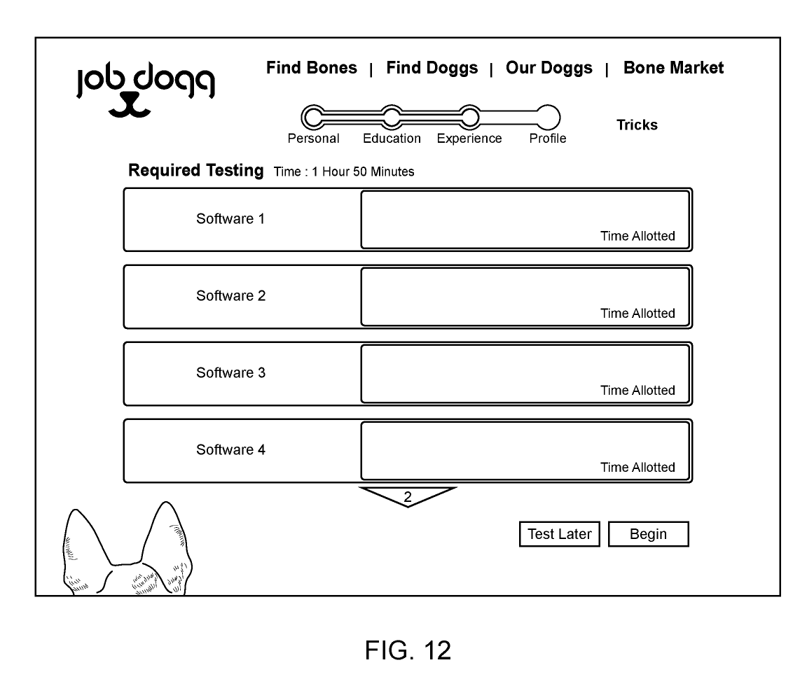

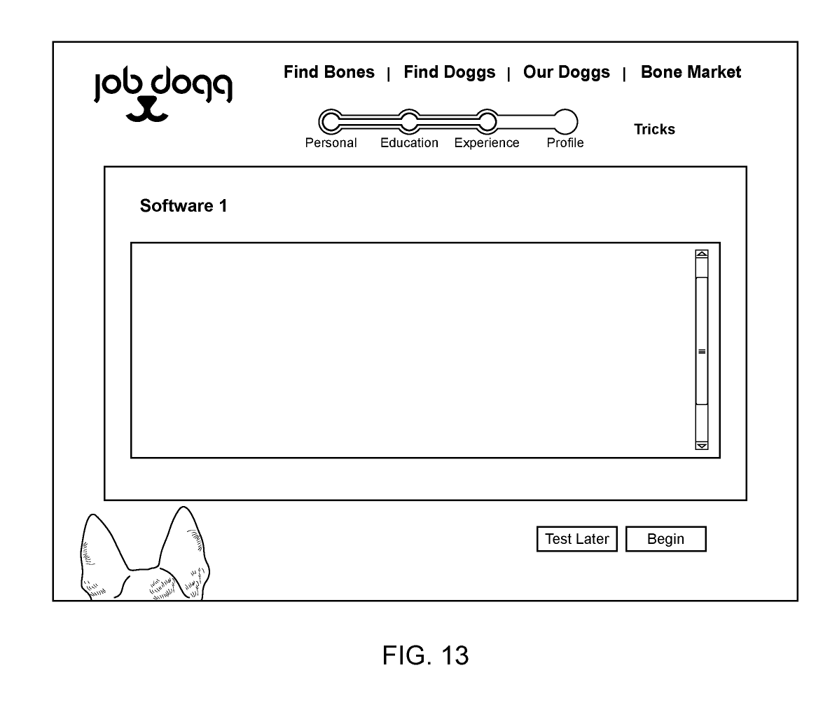

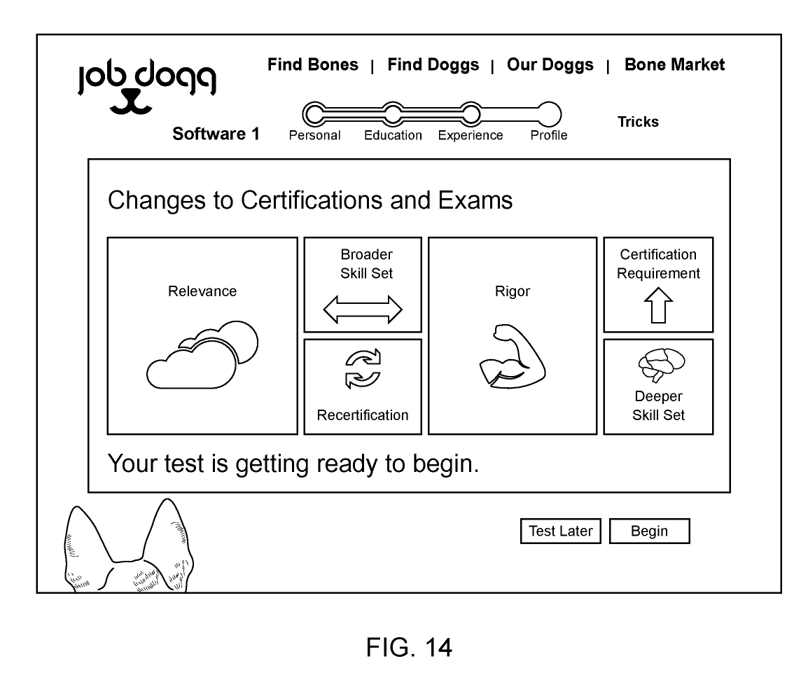

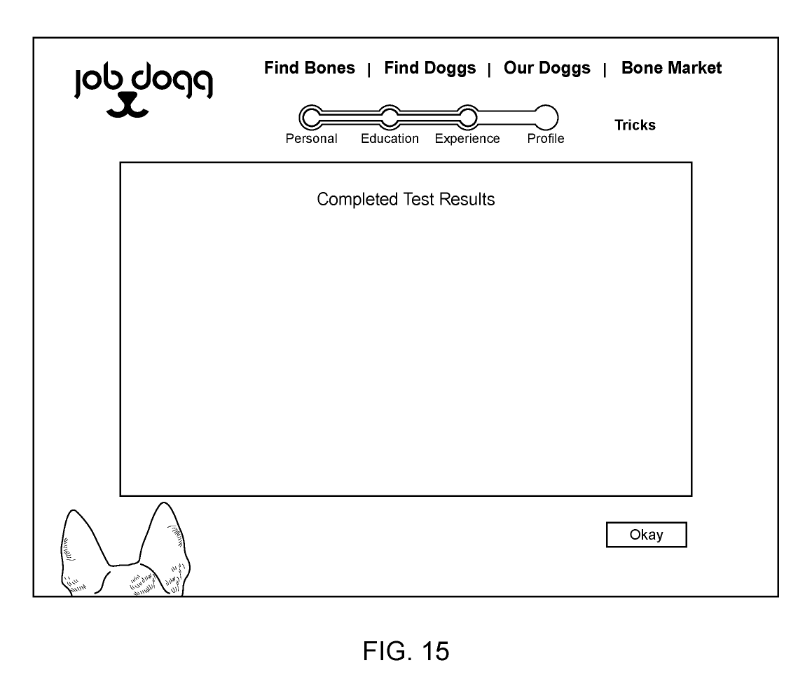

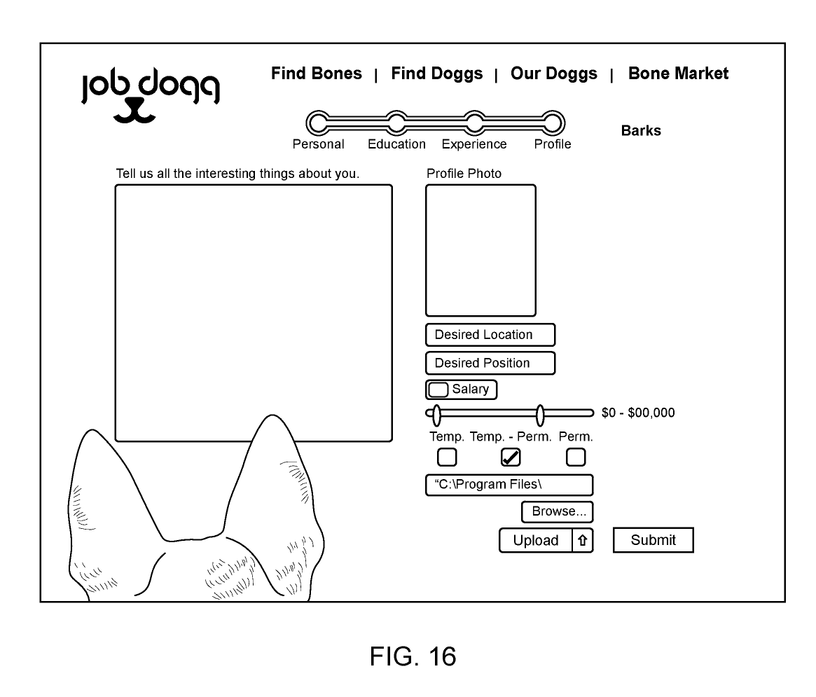

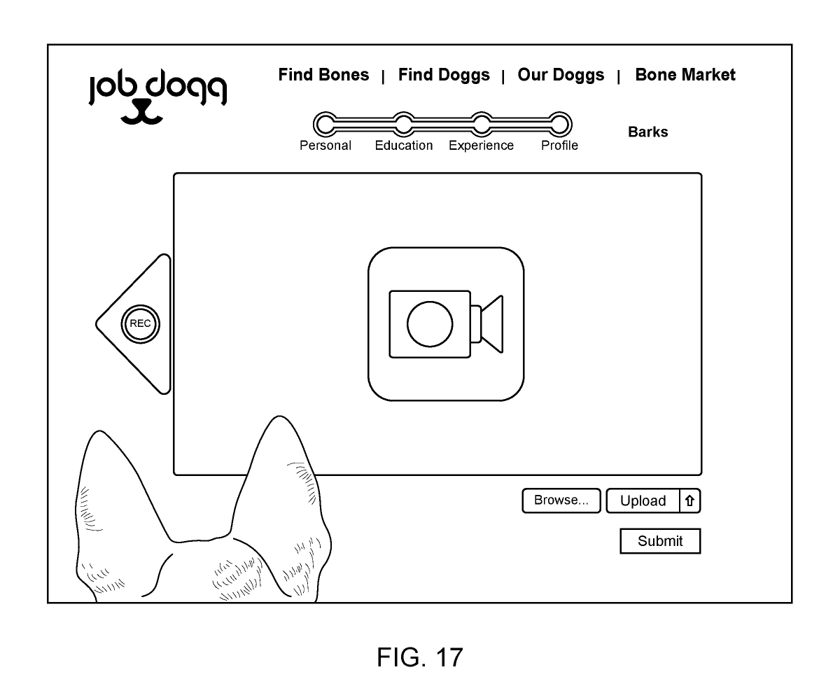

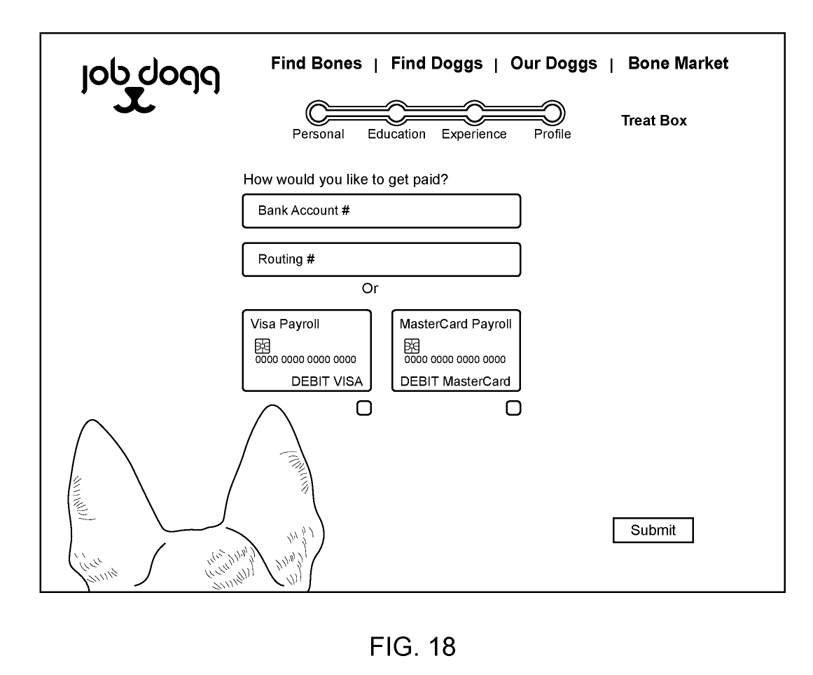

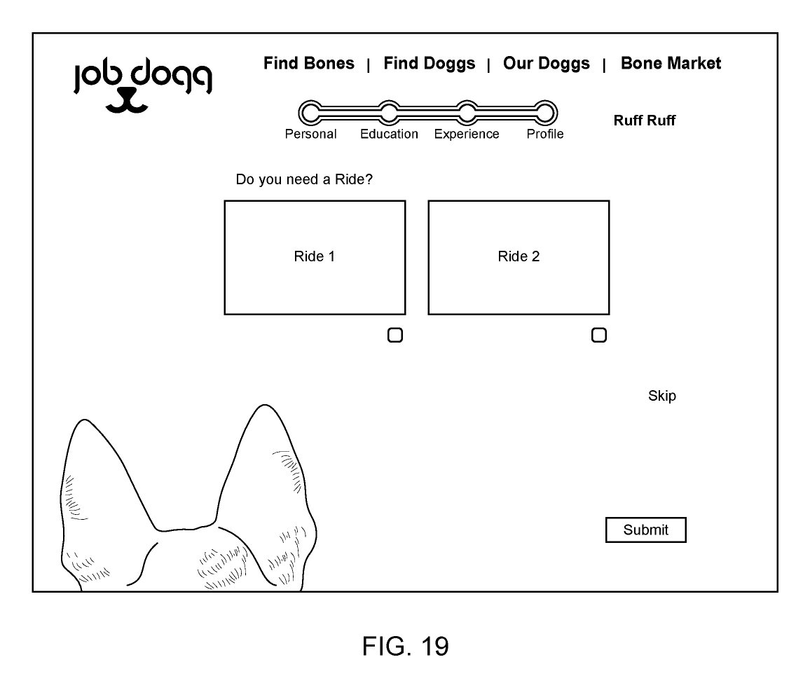

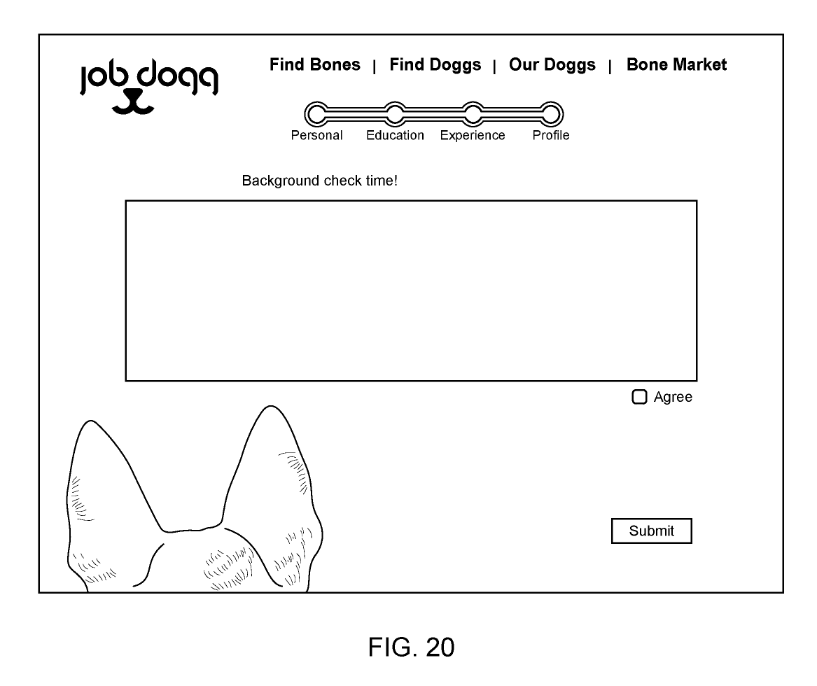

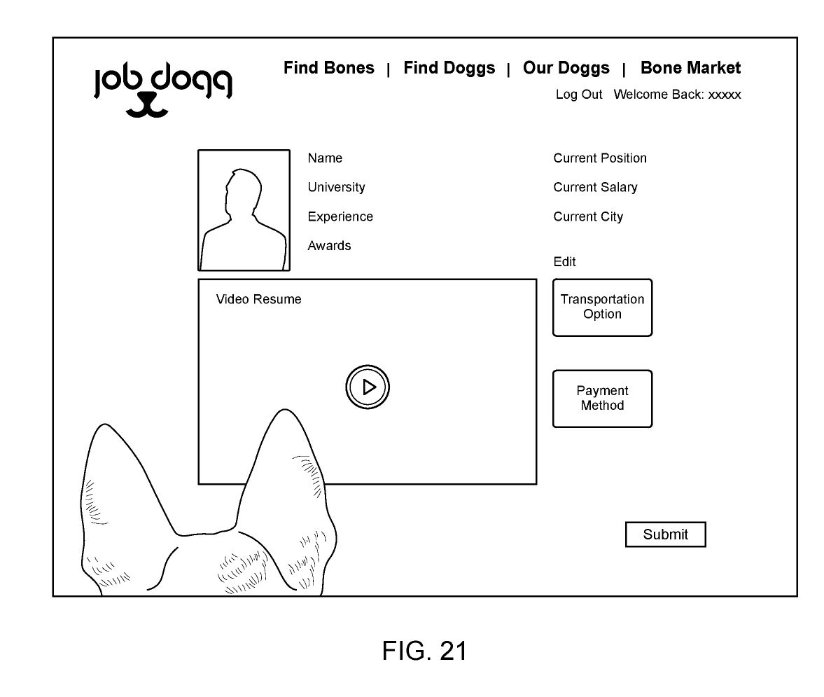

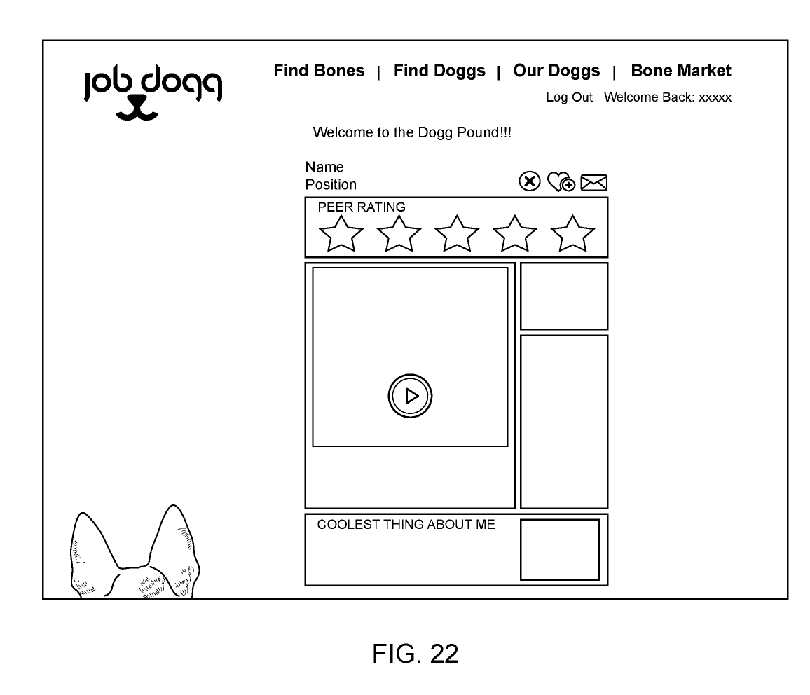

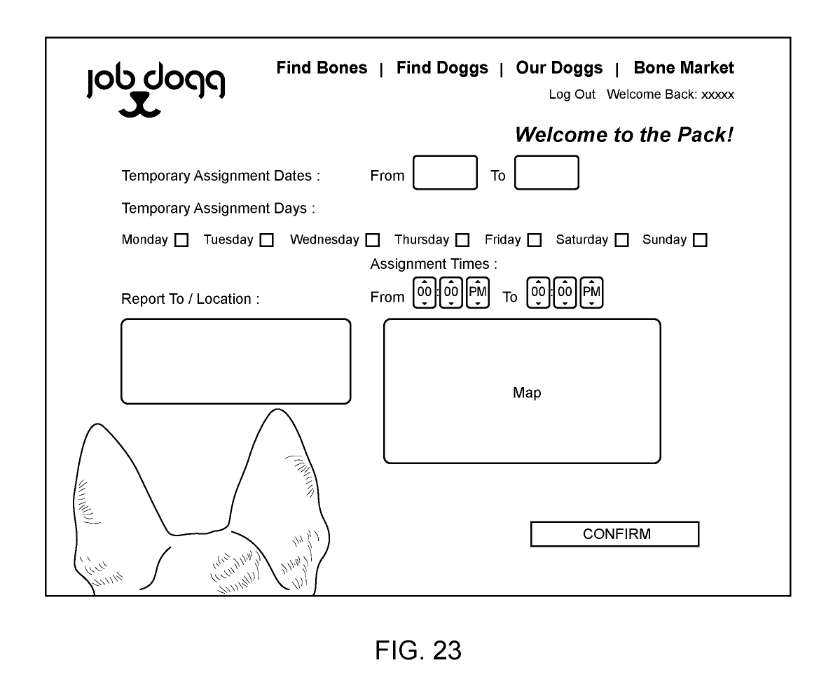

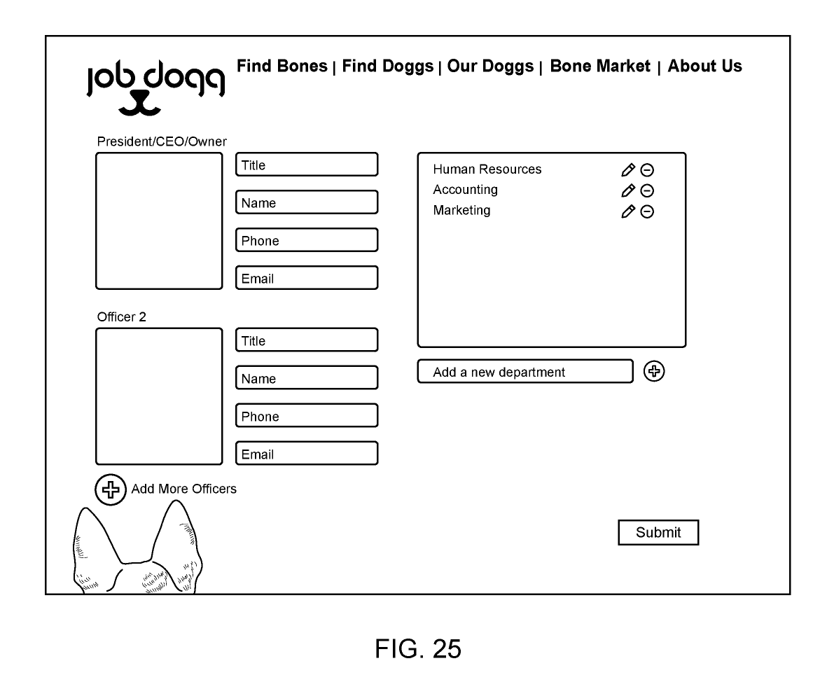

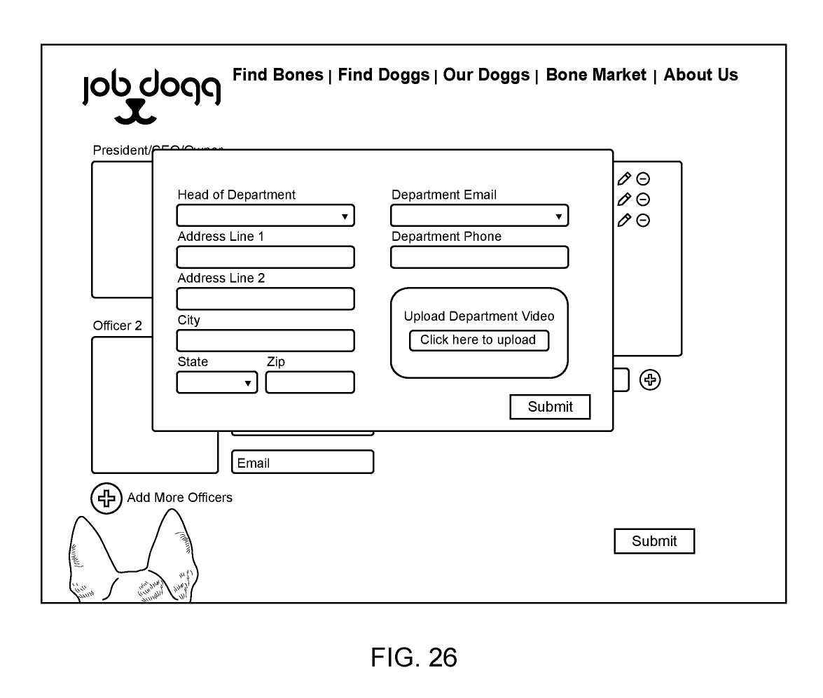

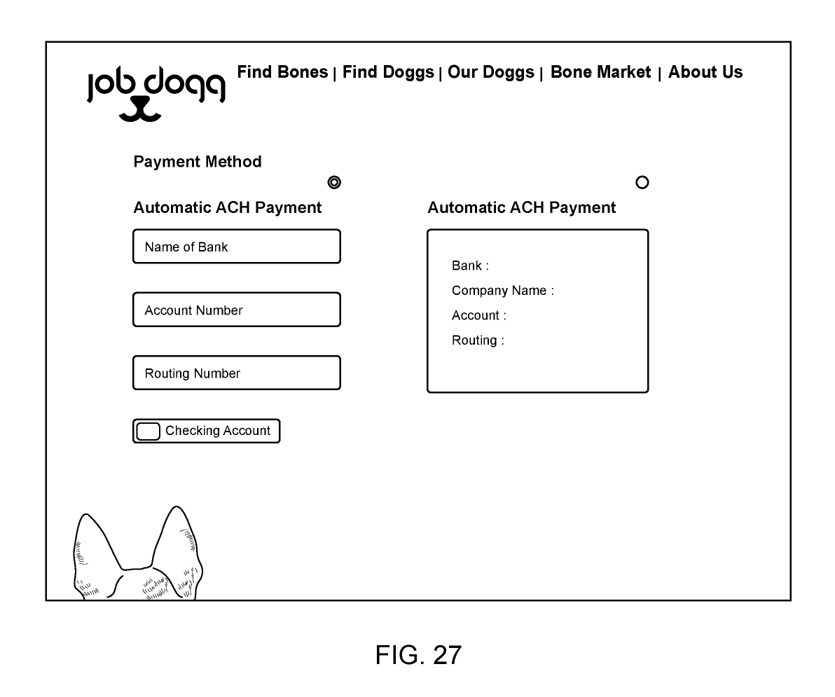

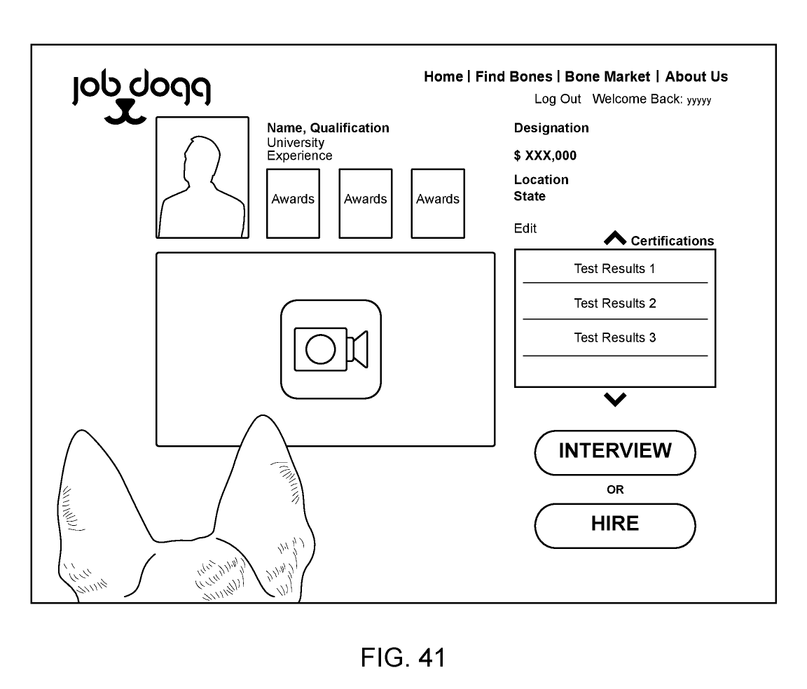

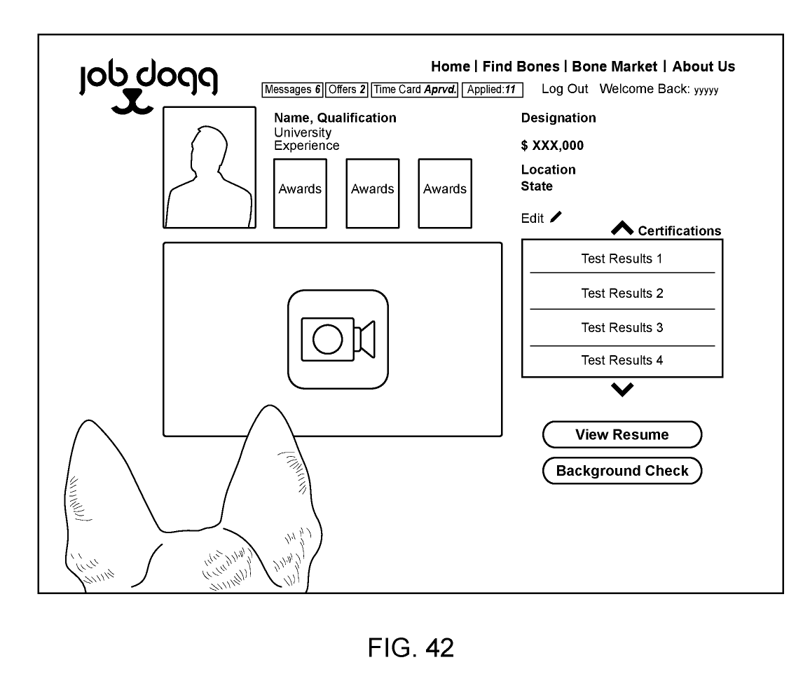

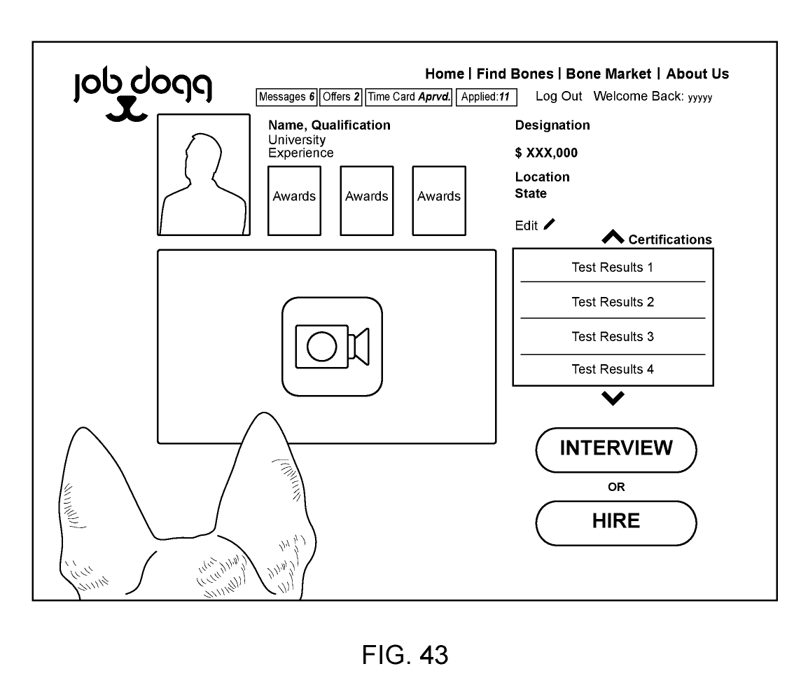

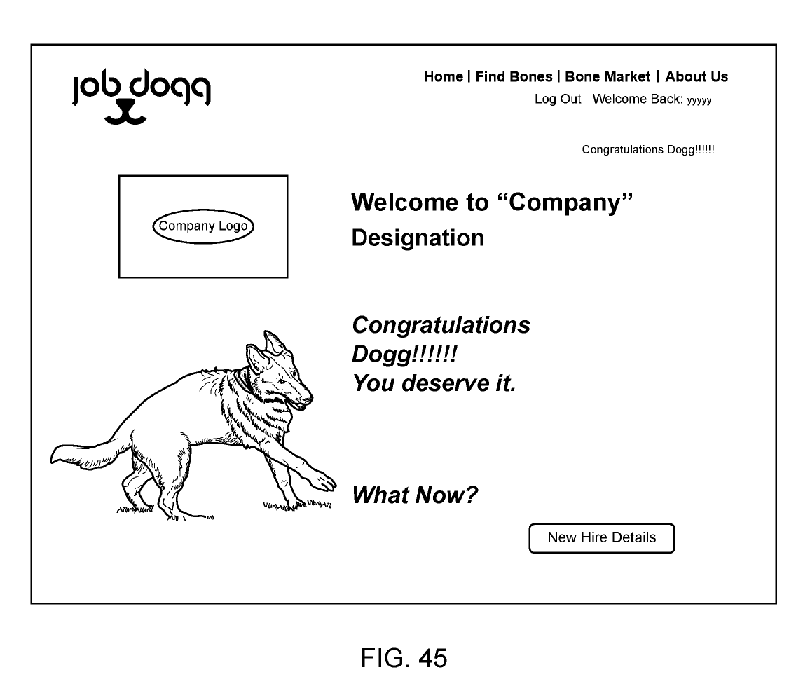

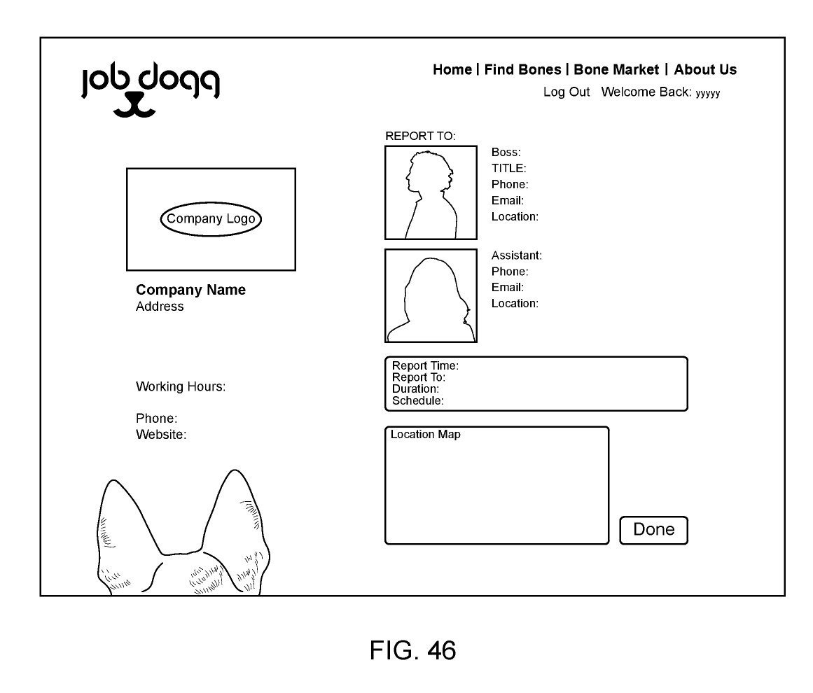

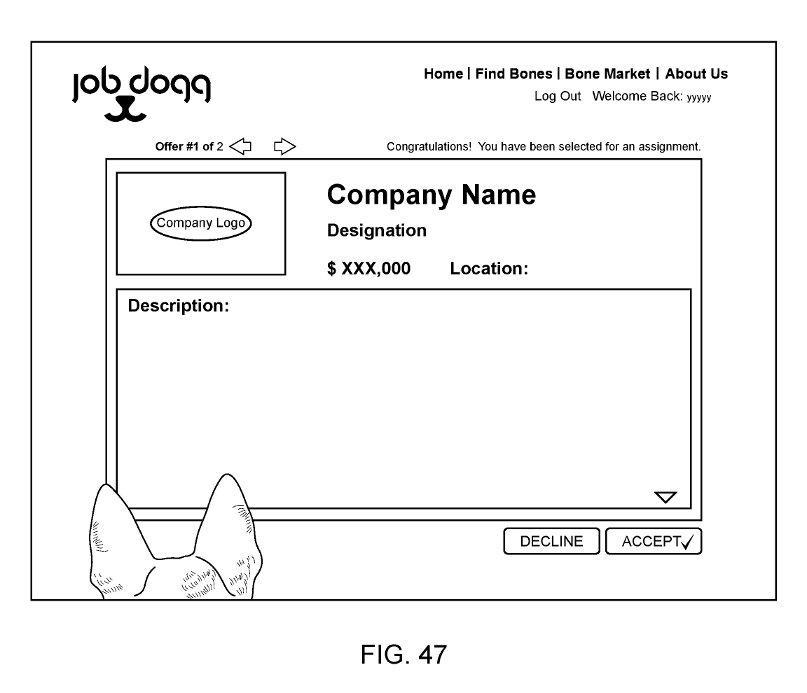

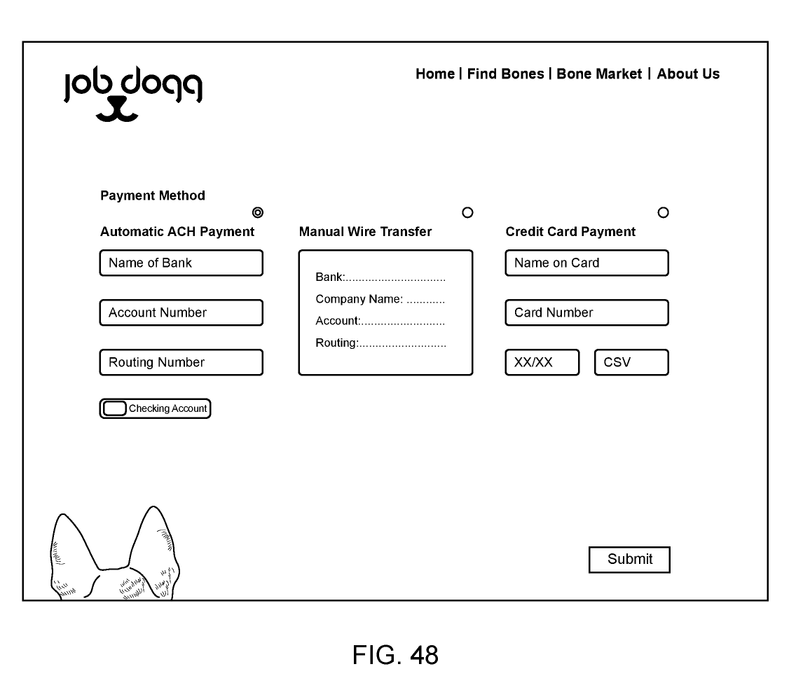

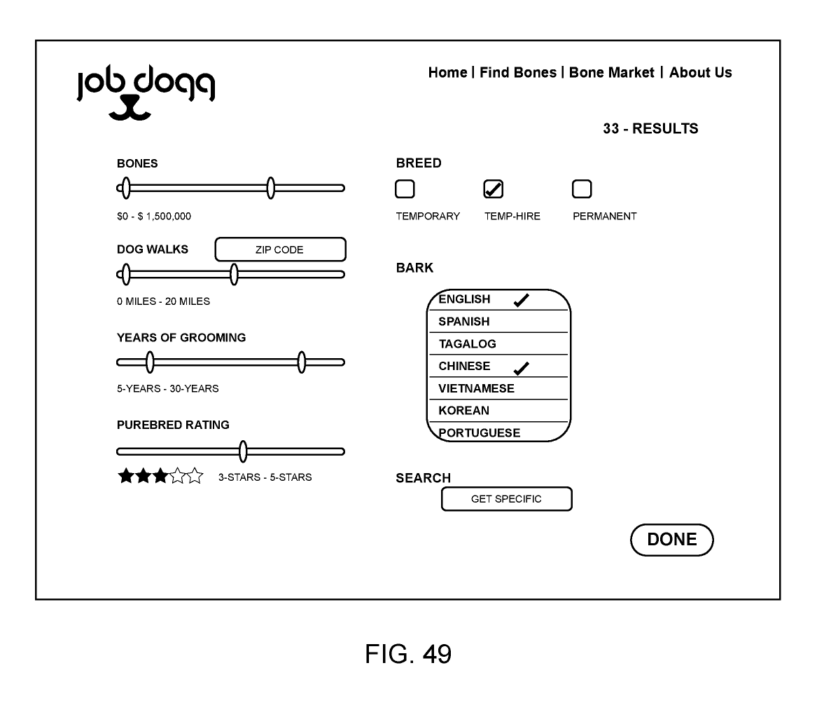

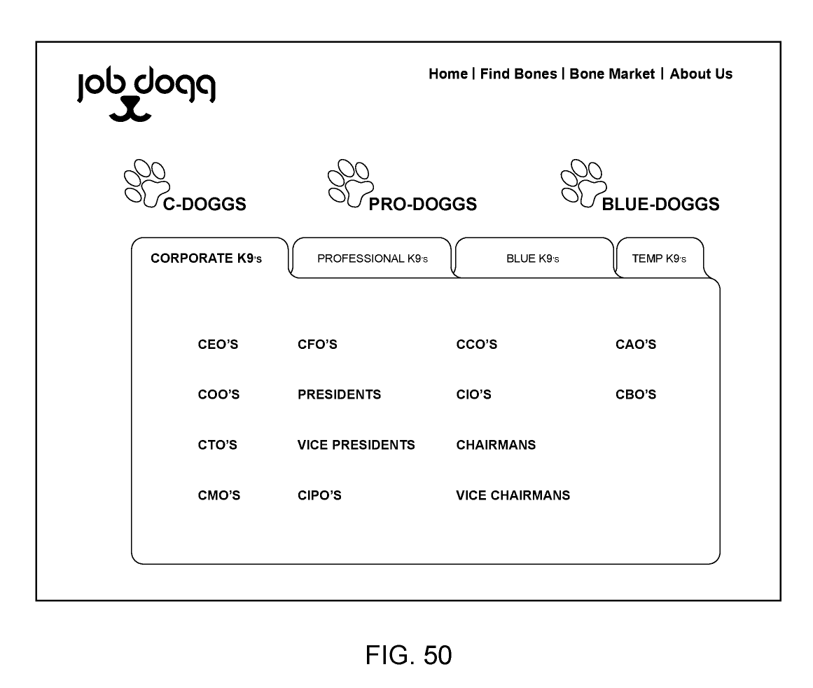

FIG. 3-FIG. 50 illustrate screenshots of web pages of the transactional service software application of the present invention. The screenshots of the web pages provide exemplary embodiments of the invention, which are referred to by the non-limiting name of “JOBDOGG”, and which schematically and pictorially illustrate various user interfaces for providing the systems, methods and features as described herein. FIG. 3 is a screenshot illustrating an initial screen of the transactional service application. The initial screen enables the user to register or log-in as an employee or employer in the transactional service software application utilizing the registration or log-in module on the home screen. The initial screen also comprises the animation including an artificial intelligence analytic. The animation utilizes artificial intelligence to mine information on the user visiting the transactional service software application. The animation uses this intelligence to address the user on a personal level by doing things such as greeting them with their name and looking at jobs that they have searched for on other sites and confirming verbally that those are still the types of jobs that they are interested in. This allows the user visiting the transactional service software application to have a much more personalized experience and that will convert into a better customer experience. The artificial intelligence also used during post login to continue the warm customer experience and better dial in what the user is trying to accomplish. FIG. 4 is a screenshot illustrating a plurality of terms of the transactional service acknowledgement process for the user, both employee and employer in accordance with the present invention. The user has to accept the plurality of terms of the transactional service acknowledgement process before they can continue or move forward with the transactional service process.

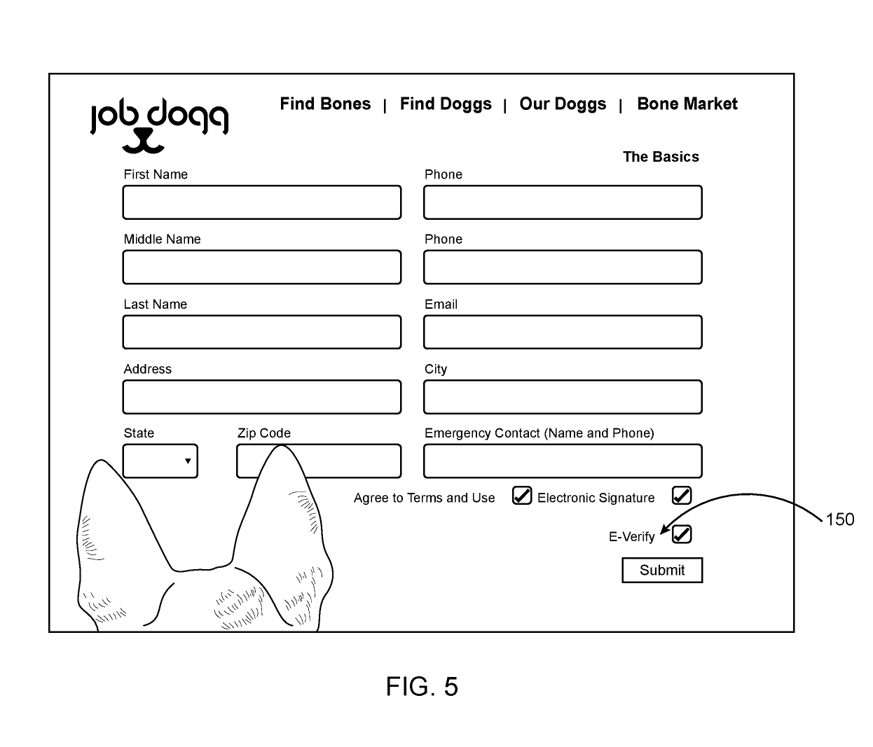

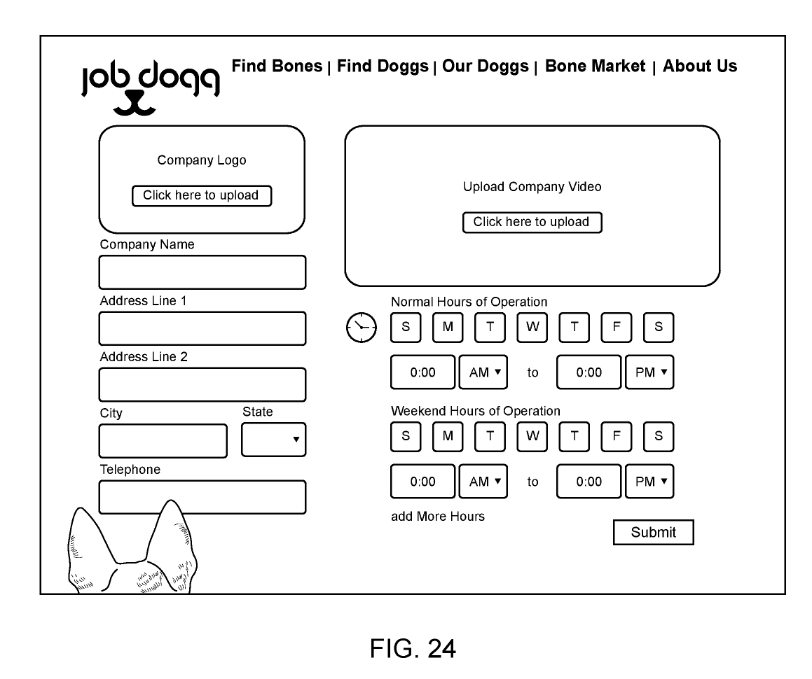

FIG. 5-FIG. 23 are screenshots illustrating personal profile creation of the employee by providing a plurality of personal information utilizing the welcome module. The personal profile creation further includes pre-screening the employee with the at least one or more of the E-Verification 150 (3^{rd} party government portal to verify authorization of work status), by uploading confidential personal proprietary information on the employee, the mandatory identification of the employee will include: Driver License, Passport, birth certificate, Social Security Card, etc. and as mandated by the Department of Homeland Security (DHS), background check, the at least one reference check and the at least one drug test, verifying pre-qualification of the employee by testing the at least one skill-set and the at least one skill-certification, uploading the video presentation of the employee highlighting the at least one employment background, the at least one professional experience, the at least one talent and the at least one accomplishments and finally providing rideshare options to and from work with partnerships/3^{rd} party integration with Uber and Lyft. If the employee selects a rideshare option, he/she has the option to have their incidentals directly deducted from their pay from one of the payroll options they selected, via direct deposit to their bank account, placed on a “JOBDOGG” issued Visa/Mastercard Debit Card or receive a paper check via U.S. Postal Mail. The personal profile creation includes pre-screening the employee with the E-Verification process 150 by the 3^{rd} party government portal, E-Verify 150 enables the employee to provide the federal government with the employee I-9 information to confirm that the employee is authorized to work in the U.S. If the E-Verify 150 cannot confirm that the employee is authorized to work in the U.S., the system will give a written instructions and an opportunity to the employee to resolve the issue regarding their employment status. All candidates available for hire have been pre-screened by background check, skill set tested (based on skills and job titles they have selected), referenced check, and E-Verified and cleared for employment to have their profile made public to the proprietary spinning rotating carousel for selection and alerts for temporary, temp to perm and permanent assignments. A video resume may include the video presentation of the employee, the employee has the ability to record their video resume that shows the employer who the candidate really is, what their communication style is like, what they have to offer and if the candidate is a good fit for their environment. FIG. 24-FIG. 27 are screenshots illustrating providing a payment method for annual membership dues and mark-up fees/rates for temporary and temp to perm employees and a flat fee or percentage on permanent candidates via an established account set-up, the ACH wire transfer/bank draft, or Visa/MC payment directly on-line to “JOBDOGG”. Employers can create a company profile and department profiles of as many departments within their organization, along with identifying department heads by providing the plurality of company information utilizing the registration module. The company profile creation further includes providing the brand advertising and the banner advertising combined with the at least one live video presentation and the at least one job posting/requisition by the employer. The company can brand advertise through video-streaming, displaying the live commercial/video tour of the companies' history, benefits offered, and all other aspects of their company. The banner advertising is also available for companies that are seeking to advertise their company for greater brand recognition. The recording of at least one live video presentation is optional. The employer profile is enabled with user friendly option for hours of operation and auto populate option for telephone number, address, etc. The employer profile is further enabled to add departments and departmental information with drop down list of department heads/supervisors of departments within the company. The profile page is provided with a logout enablement function that allows the employer to logout even if the employer is in the middle of building their profile and can come back at a later date to the same page.

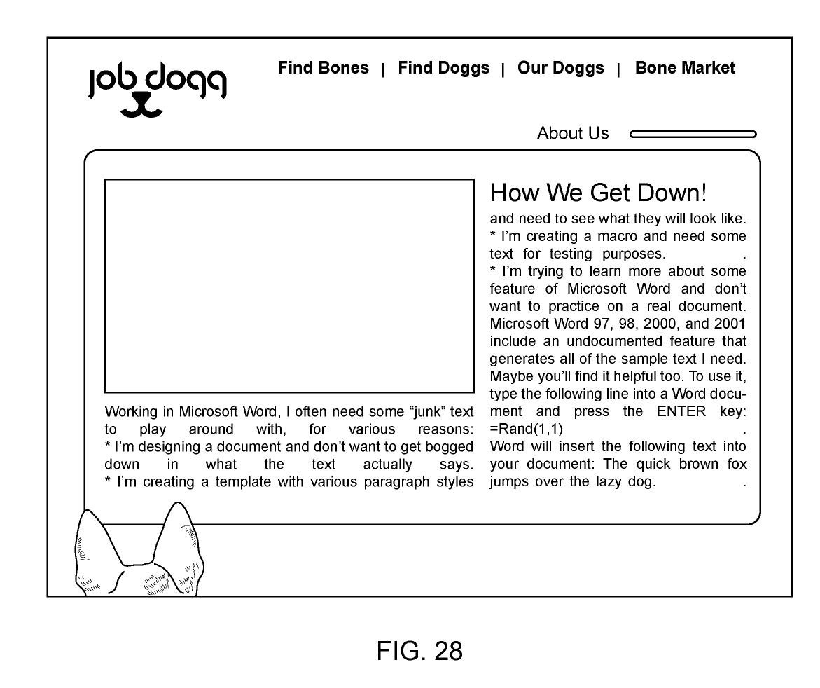

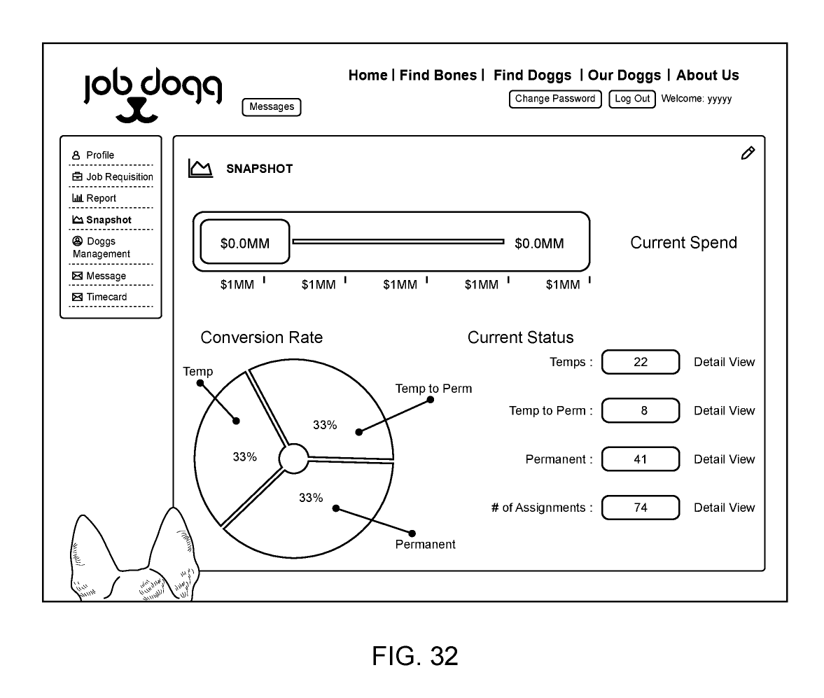

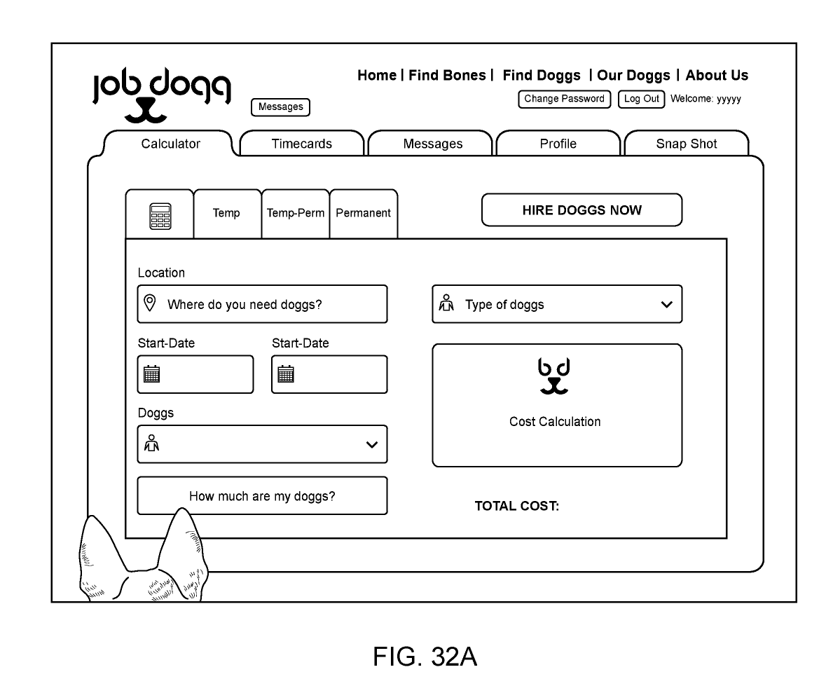

FIG. 28-FIG. 32 are screenshots illustrating employer dashboard. The employer dashboard includes the plurality of company information. The employer dashboard comprises their profile, options to open and create job requisitions/postings, option to view, download and print reports in the report/business analytics module, giving a snapshot/birds eye or full view of their hiring and staffing trends with statistical data and information, a messaging option to message to and from candidates, timecard module to review, reject, approve, complete or convert a temporary or temp-perm assignment, and a built in calculator, employers are able to calculate the cost of human capital, “prior to hire” before committing those resources by utilizing the built-in calculator as shown in FIG. 32 A.

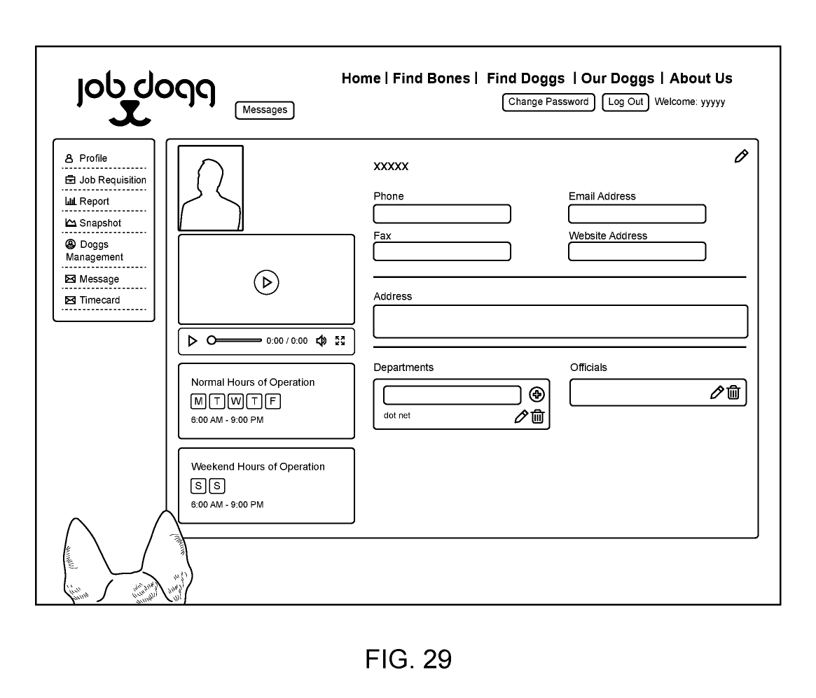

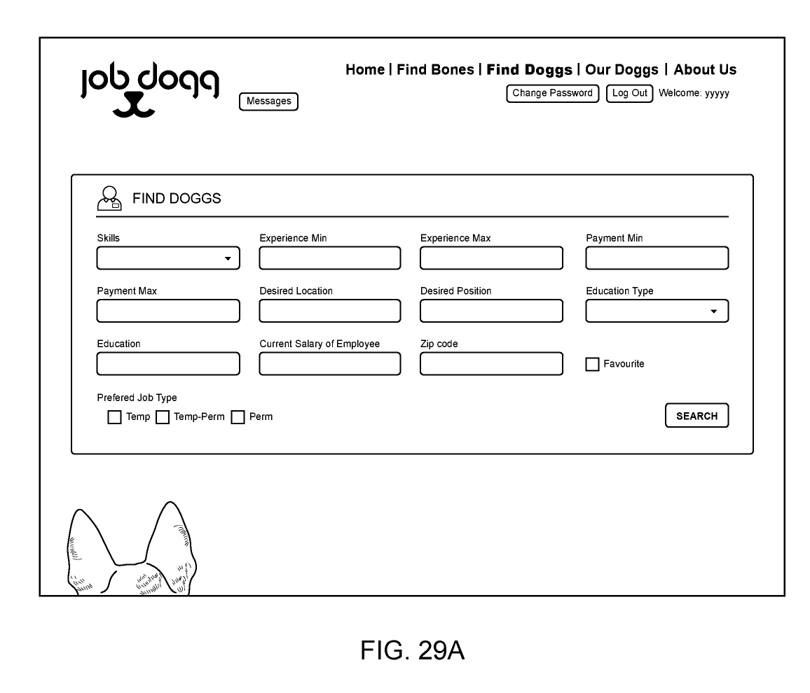

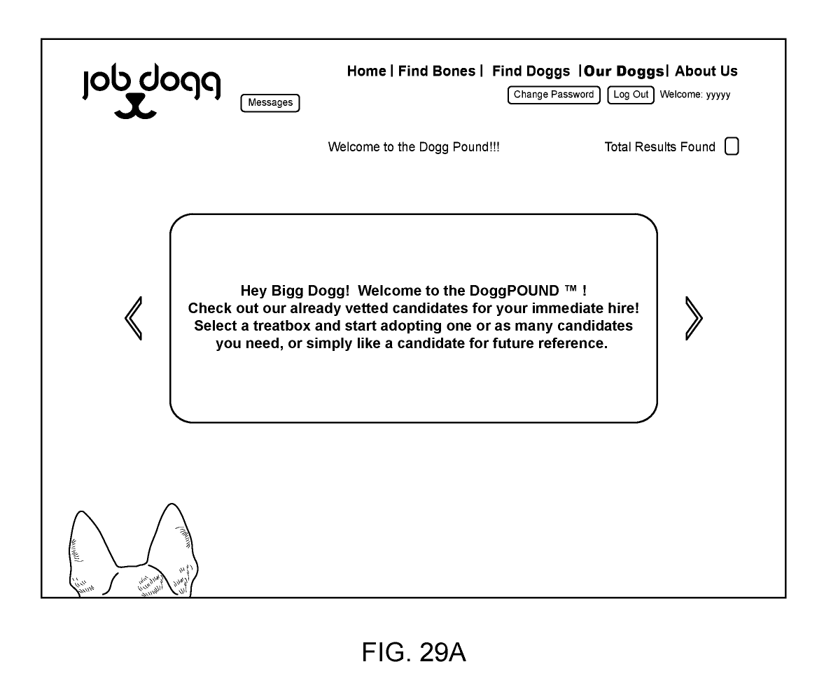

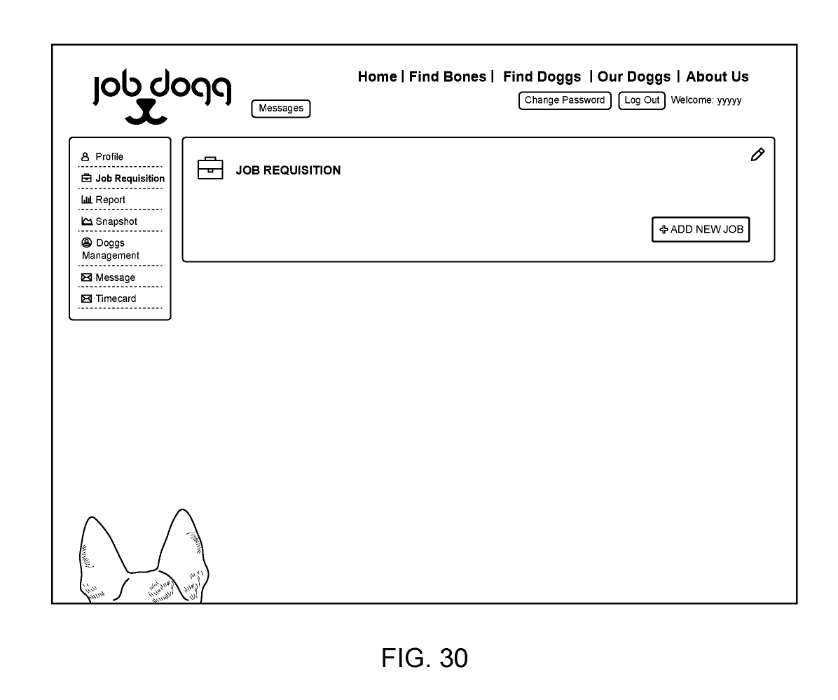

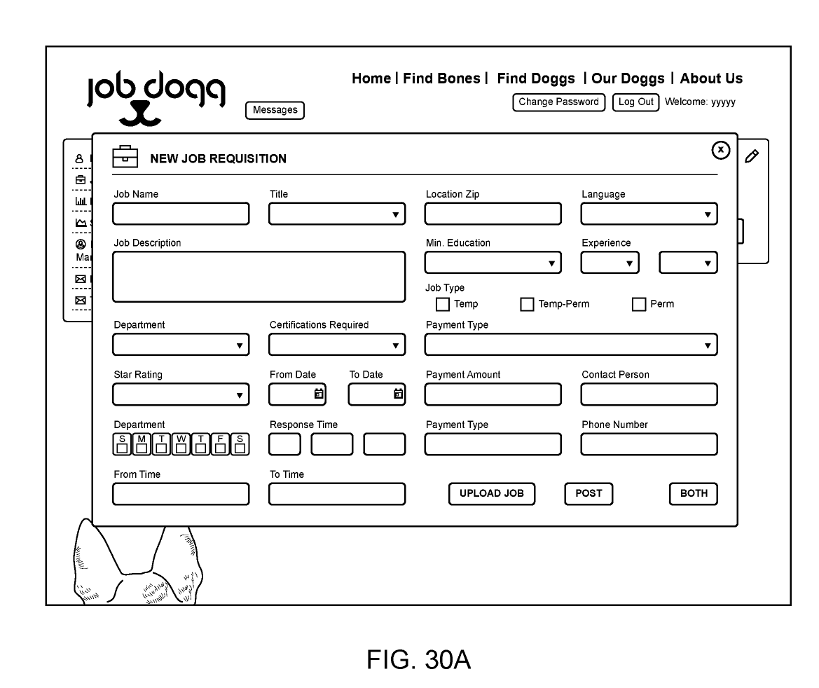

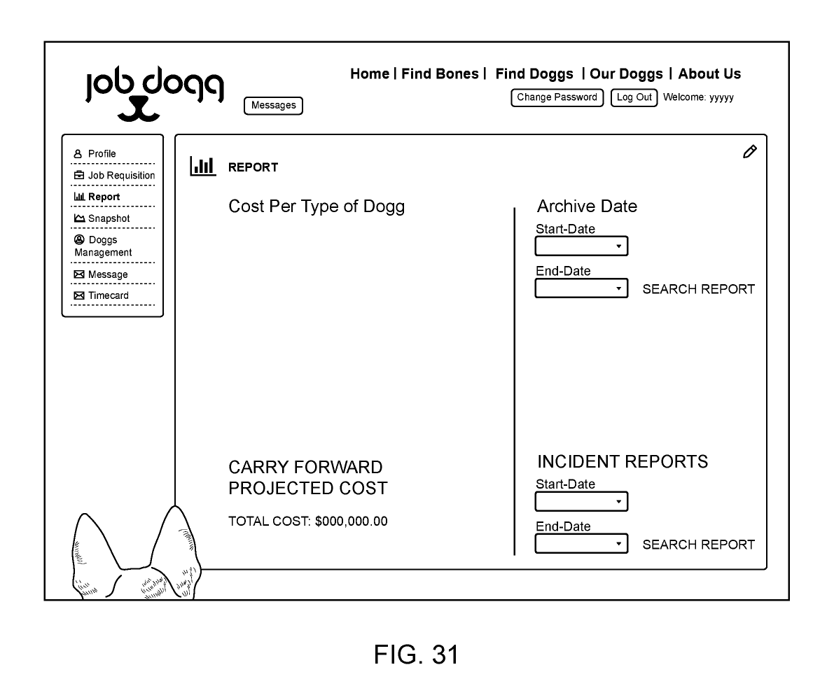

FIG. 29 illustrates the profile page of the employer dashboard. FIG. 29A illustrates “find dogs” page to search and find a candidate for a specific criteria, job requirement or skill-set and FIG. 29B illustrates “our dogs” page illustrating all of JOBDOGGs' candidates in the system of the invention on the proprietary spinning carousel of the employer dashboard, the “our dogs” page includes a pop-up message displaying the candidates cleared or pending status of background, skill-sets completion and other highlights. FIG. 30 and FIG. 30A illustrates the job requisition page of the employer dashboard. The job requisition page allows employer to create a job requisition, includes open jobs, closed jobs and archived jobs. FIG. 31 and FIG. 32 illustrates the report page and snapshot page of the employer dashboard respectively. The reporting and management solutions allow the employers to view their spending trends

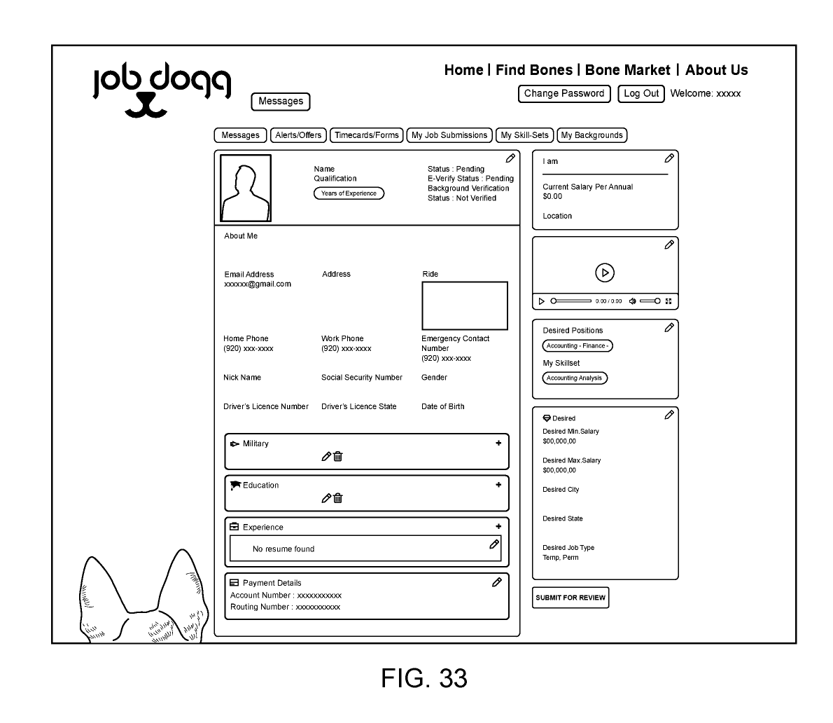

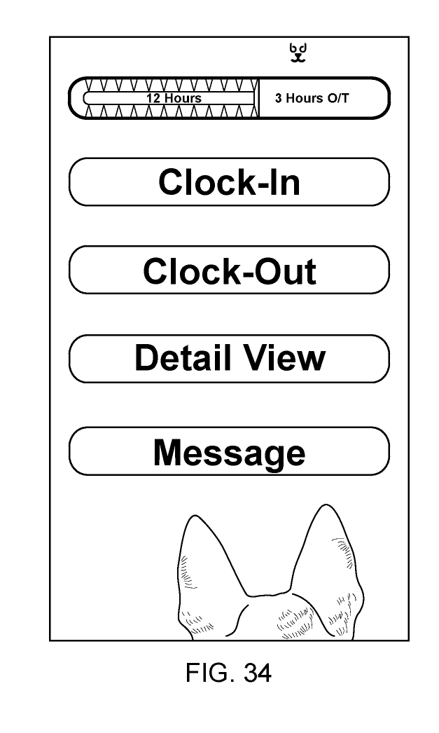

FIGS. 33-38 illustrates employee dashboard, the employee dashboard comprises messages, alerts/offers, timecards/forms, my job submissions, my skill-sets and my backgrounds. FIG. 34 illustrates a mobile timecard view. The employee can record the daily attendance time sheet, clock in and clock out events including a Global Positioning System (GPS) location data. The timecard full view details are displayed in the employee dashboard. The employee is enabled to log time daily. An employee will have the option of accessing the time card from their dashboard or mobile device. Timecard link will only be active if the employee is working a temporary or temp-perm assignment. The employee on a daily basis will clock in/out which will give the current time of when the employee clocks in/out, the system will automatically calculate the actual hours worked which will auto populate on the time card, it will also calculate and populate overtime, double time, and Holiday pay. If an employee is a “No-Show” for their assignment on their initial start of their assignment the timecard will automatically be disabled and a message will automatically be sent to the employee for further instructions via email, SMS/text messaging, and will also be messaged on their dashboard under their messaging tool. If the employee has not properly communicated with the employer an absence, out sick, etc. via timecard module on their day of duty, the employer has the power to block further access by the employee to his/her timecard. This may further lead to termination of the assignment and further instructions will be sent to the employee from the system giving instructions for reactivation of their profile.

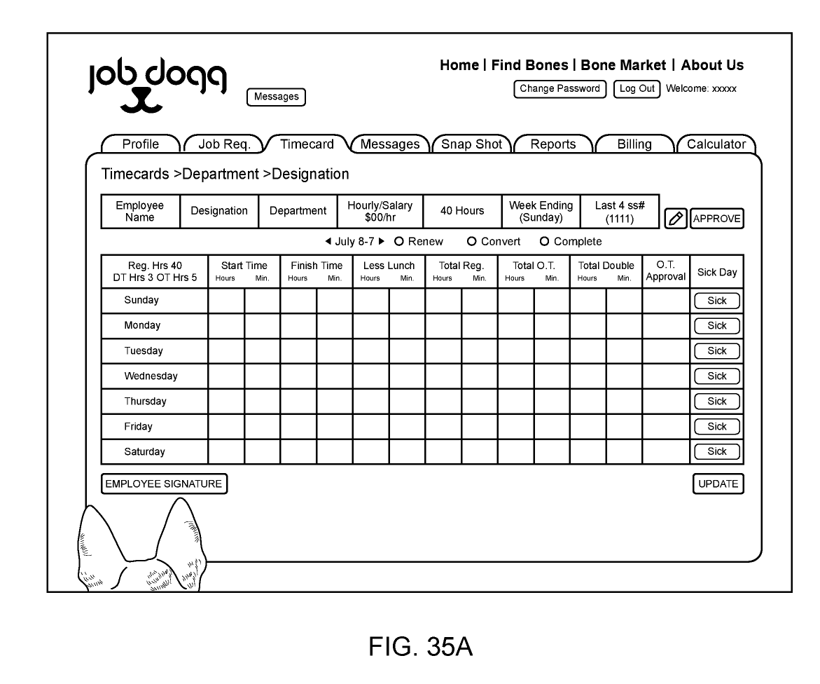

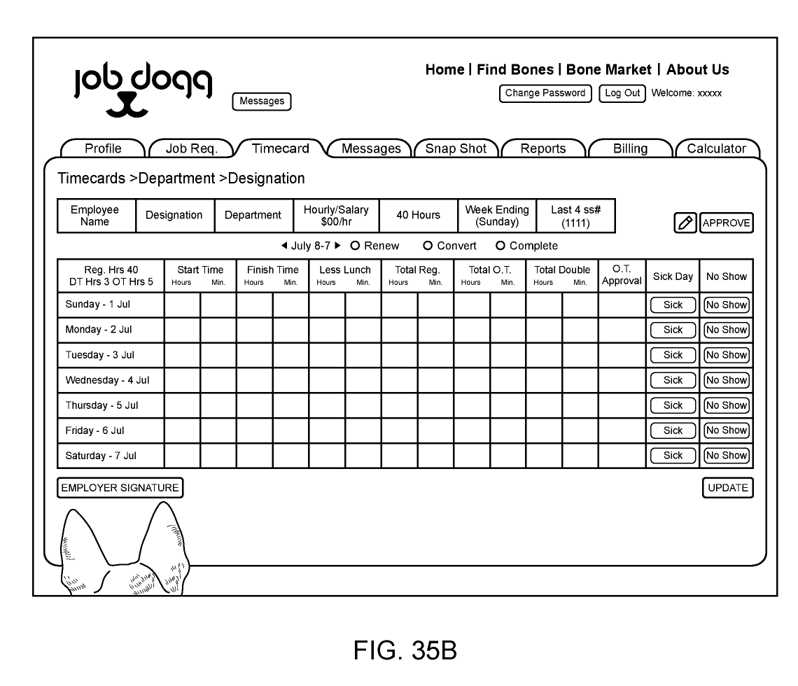

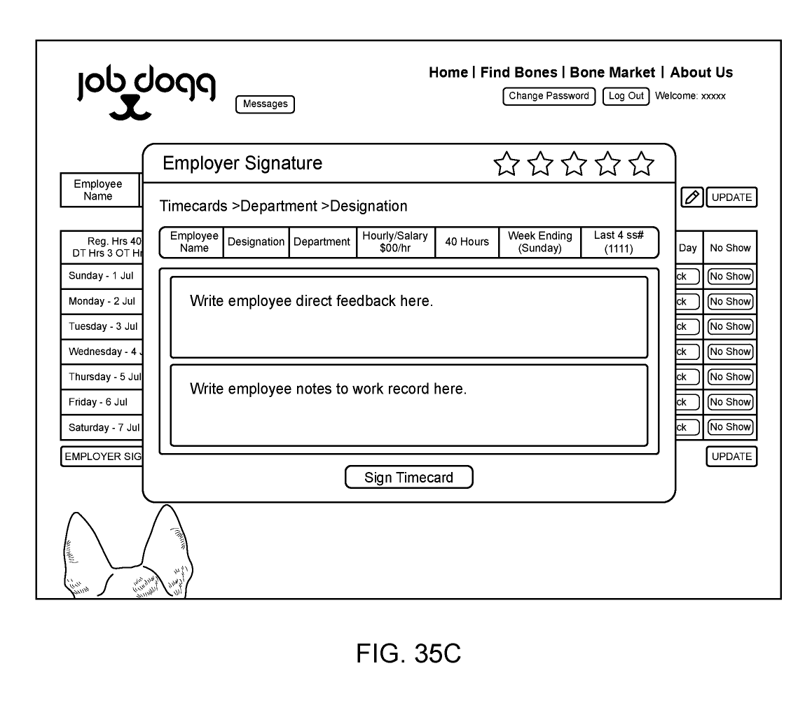

FIG. 35A-FIG. 35C are detailed views of the employee timecard and the employer timecard. FIG. 35A and FIG. 35B are the employee timecard and the employer timecard respectively. The employers and employees have the ability to manage timecards online or directly from their mobile device. A “2-way” messaging functionality is also built into the platform to address any matter in real time, the messages also appear as a text message. The employer will have several options when approving the employee timecard such as renew, complete and convert. The renew option indicates that the employees' assignment has been renewed, and that the employee can continue the same assignment until such time employer decides to complete or convert his/her assignment. The complete option indicates that the employee assignment has been completed, when the project is completed and the employee's task is over, the employer can select the complete option. The complete option further indicates that the employee is placed back into the public profile on the proprietary spinning carousel, where the employee can be selected for other assignments. If the employer decides to convert the employee onto their payroll the system will automatically calculate the remaining hours to be worked i.e., the employee must complete 520 hours on JOBDOGGS' payroll prior to being converted onto the employer's payroll, which automatically calculates when the convert option is selected. If the employee has completed 520 hrs, the employee can convert to the employer's payroll with no extra charges or fees, upon conversion the employee will no longer be active or accessible on “JOBDOGGs” public profile spinning carousel, until such time the employee/candidate reactivates their profile page with updated information, to re-qualify with a new background check, skill-set test etc. Upon a completion or termination of an employees' assignment, the employee's performance can be rated by the employer on a 1 to 5 star rating scale along with detailed notes which can be input on the timecard star rating pop-up page. The rating will be visible on the employee's dashboard, as well as displayed on their profile on the proprietary spinning carousel.

FIG. 35C illustrates the rating pop-up page, the pop-up will only occur when employer selects “convert” employee, when the employee has “completed” an assignment or has been terminated. The pop-up includes at least one text box, which is enabled to write a review and rate the employee. The review is considered a reference and will remain as a permanent reference in the employees' personnel file. The timecard module comprises a built-in messaging/communication tool for both the employer and the employee. The employee and employers' dashboard run in real time running 24 hours 7 days a week. Upon completion of a temporary or temp-perm assignment, the employee can electronically sign the time card and ensure and agree to the true and accuracy of their time input. When the employee completes the timecard, they will have an option to choose to have direct deposit, have pay on a “JOBDOGG” pay card or have a paper check mailed. The timecard module is also enabled to receive W-2's annually. If an employee does not submit their time by the timecard submission deadline, the employee will have ability to submit the next payroll ending to be paid the following week. The employee can hit submit button to submit the timecard to the authorized department head for approval. Upon the employee clicking the submit button an alert will be sent to the employer to approve or reject, upon reject an alert will be sent to the employee to make the necessary edit/changes to their timecard. If approved, the employee will get and automatic approval notification electronically via an employee personal email, SMS/text messaging and via the employee dashboard of a successful approval, rejection or to make edits and re-submit to ensure being paid on time. On the employer's dashboard all of their hires, expenditure, department costs, job classification codes, archives, etc. can be accessed in real time, downloaded and printed at any time by utilizing the report module. A built-in communication tool is provided between the employer and the employee on the employers and the employees dashboard. A star rated employer rating system or peer rating system is also built in the system.

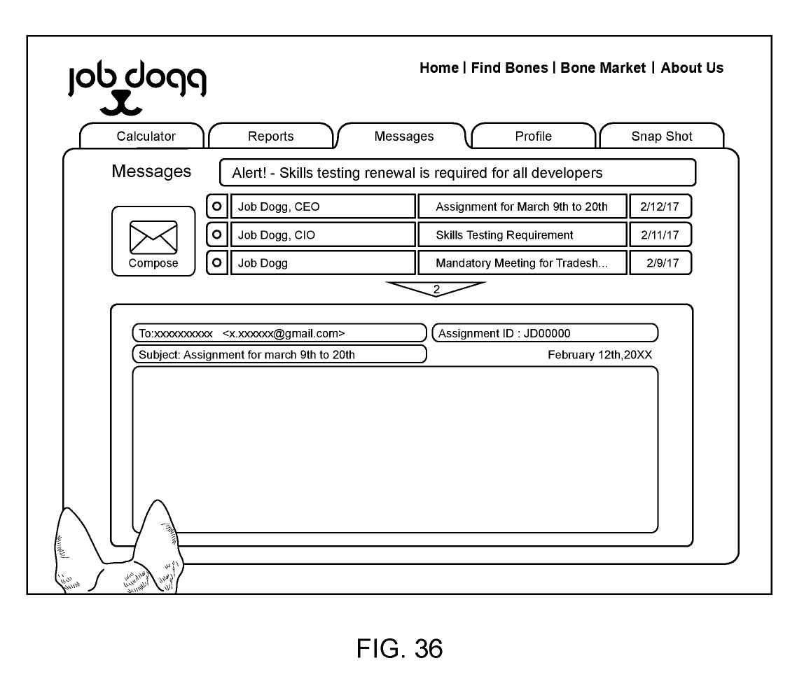

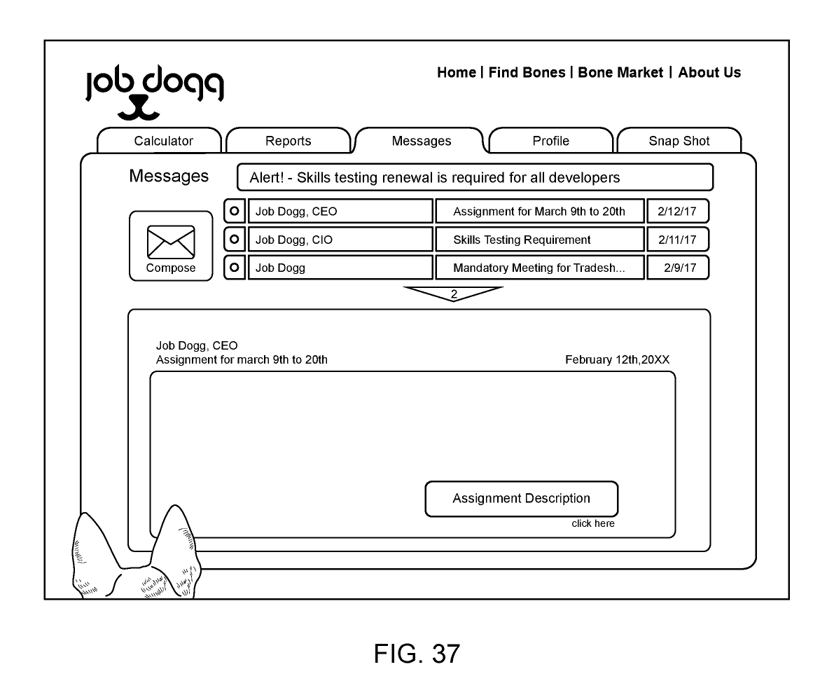

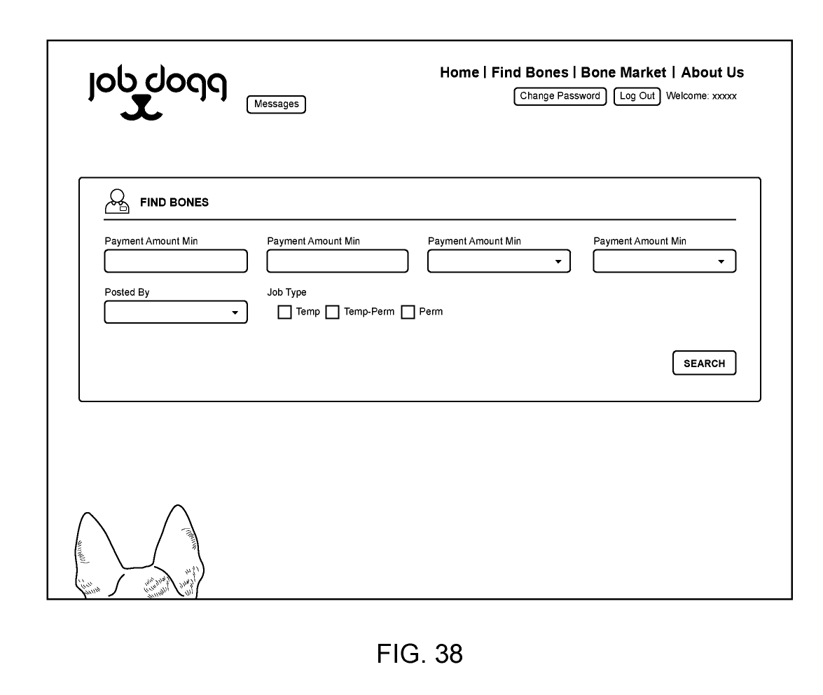

In the employee dashboard, the employee can see the messages received, the assignments placed on, the time duration of work, reviews from prospective employers as well as employers who have viewed/interested/rated, internal/external notifications, i.e. timecard issues, assignments, etc., upcoming events, hot jobs, W-4 etc. as shown in FIG. 36 and FIG. 37. The employee can search for at least one temporary or temp-perm job assignment or at least one permanent full-time assignment and access the at least one job posted by the employer as shown in FIG. 38. The live video presentation can be added in the dashboard to greet the employer. In the message box, the alert of the at least one temporary or temp-perm job assignment or the at least one permanent full-time assignment by email and/or SMS text message is received. On the employees' dashboard all of their confidential inputs can be accessed in real time on their dashboard and changes/edits can be made on their dashboard.

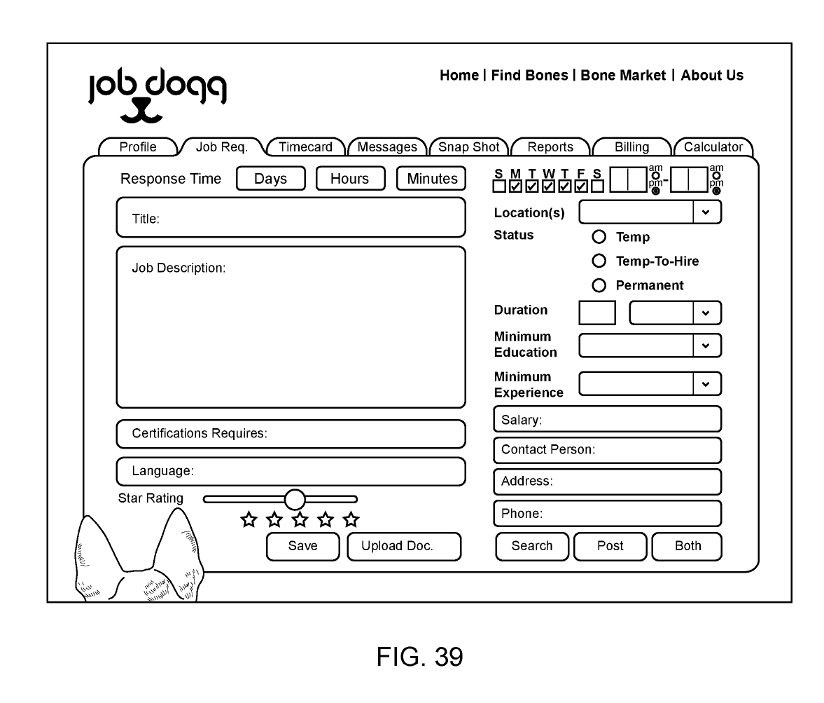

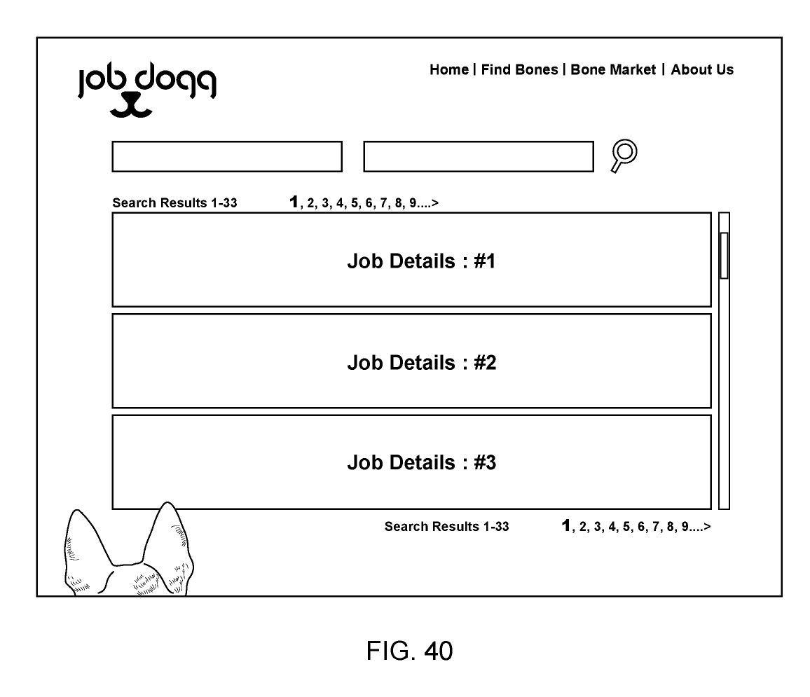

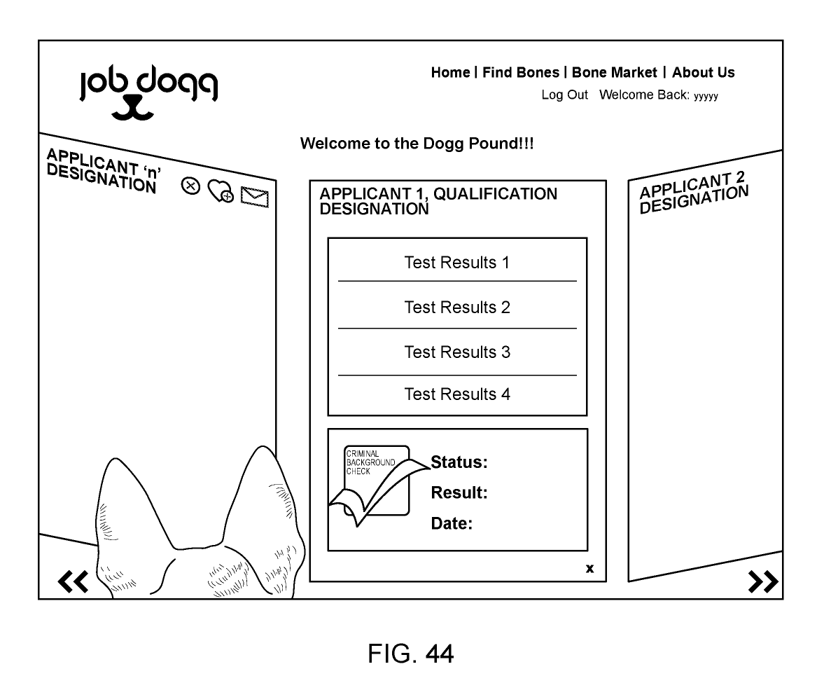

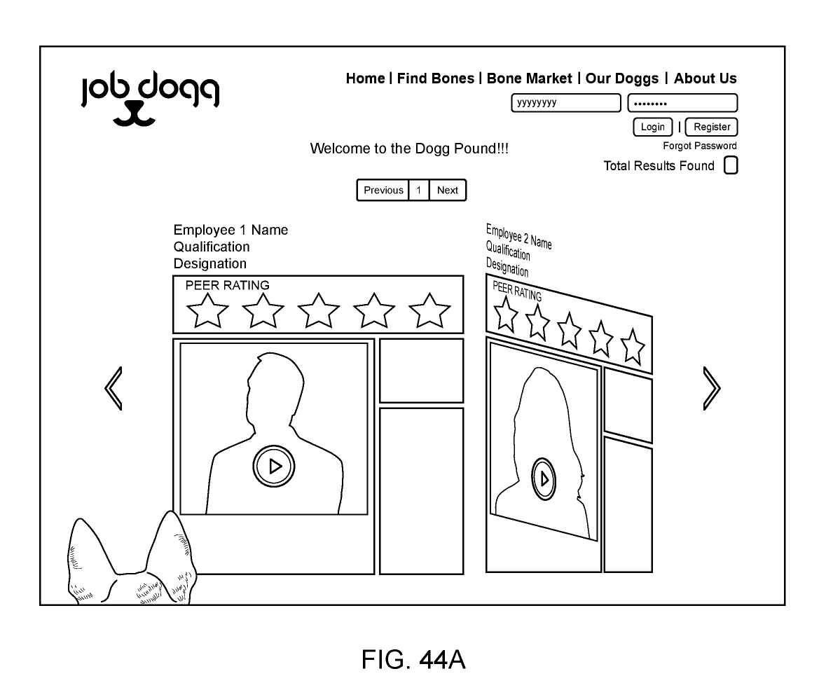

Turning now to FIG. 39, the job requisition page of the employer dashboard is illustrated. The employer has access to a pool of temporary, temp-perm, and permanent candidates to be viewed, favorited, alerted and hired instantaneously. The employer also has the option to build a job requisition identifying their required candidate and has the option to pick one or as many temporary, temp-Perm or permanent candidates. FIG. 40-FIG. 50 illustrate screenshots of various stages of recruiting by the employer. The employer can view the personal profile of at least one potential or more candidates and arrange the plurality of virtual interviews or immediate hiring. The employers have the ability to scroll through candidate profiles on the proprietary spinning carousel from left to right or vice versa and select one or as many candidates to immediately hire, interview or favorite for future reference. This will provide a speedy, quick view of already vetted candidates at a glance and allow the employers to save 90% of their human resource functions when trying to find the right candidates. Employers instantaneously, based on their query search and the method of the system of the invention allows the employer to find, select, hire or favorite the right fit. The proprietary spinning carousel gives employers a bird's eye view with the option to drill down to view a more detailed resume/profile FIG. 44 and FIG. 44A. The employer can hire the at least one potential employee at a moment's notice and send an alert to the potential candidate of the temporary, temp-perm or permanent job assignments by email or SMS text message to show up to work immediately.

The alert may go to the potential employee's mobile device, email and dashboard after the employer has selected them from the proprietary spinning carousel for an immediate assignment or permanent hire. The potential employee is selected to begin their temporary, temp-perm or permanent assignment, based on the criteria of the job requisition input by the employer. The candidates are alerted of job assignments via mobile device with “Accept” or “Decline” options. If a potential employee hits “Accept”, then a pop-up/email will appear as “Welcome to the Pack!” and further instructions will be sent to the candidate giving show-up to work specific details, report to information, along with location map of where to go. A pop-up/email and SMS/text message will also be sent to employer of the acceptance. If a potential employee hits “Decline”, then a pop-up/email and SMS/text message will appear to the employee stating, “If you decline 3 offered assignments within a 6-month period, your profile will become inactive and your profile will be made non-public for a period of 6 months”. If the potential employee accepts the assignment, the confirmation goes back to the employer/client confirming the potential employee will show for his/her assignment. The employer has access to approve, reject, make changes or edit the new associates' timecard found on the employer dashboard and the employee now has access and their timecard is now active for clock in/out found on his/her dashboard. If a candidate is featured as “No Show” the employer/client will select the icon “No Show” on the employee/candidate timecard and the employee/candidate's timecard will be disabled for no further inputs of clock in/out. A replacement will be auto selected by the method and the system of the invention or the employer has the option to re-select a candidate or candidates from the proprietary spinning carousel. Employer will receive a notification stating, “We apologize for this inconvenience. We have notified (Candidate's Name) not to contact you directly and access to their timecard has been disabled. We will happily replace your candidate with the selected candidate or candidates for up to 8 hours free, may we suggest the following candidates, Or, if you like, feel free to pick one of your favorites from Our Doggs”. The employee will also receive an email, SMS text message and a message on their dashboard stating, “Oh Snap Bigg Dogg! What Happened?? You did not show for your assignment! We are here to help! Do not contact the employer directly. Please provide an explanation of your “No Show” within 24 hours to “JOBDOGG”. Our groomers will review your explanation and notify you of your status. Remember if you “No Show” without a legitimate explanation and/or documentation, your profile can be placed inactive for a period of 3 months. In order to reactivate your status after the 3-month expiration, you will be required to undergo a new grooming service, to include a background check, skill-set test update, along with any other changes you need to make to your profile”.

Upon registering with transactional service software application 114 the employee is considered an unpaid applicant and will remain in an active applicant pool where the employee will receive job alert notifications. The employee agrees to accept job assignment notifications via email and SMS text message. Upon accepting a job assignment, the status of the employee will change to a compensated temporary or temp-to-perm employee. Once the employee accepts a job assignment, the employee will be paid on a weekly basis at a rate specified in the job assignment. The employee acceptance of the job assignment signifies acceptance of the rate of pay and schedule detailed in the job assignment. The employee will be paid on a weekly basis, following the week during which the employee has worked. Time cards must be submitted and approved electronically at the end of each work week ending Saturday, 12 midnight and no later than Monday 12 noon in order to be paid on time. The transactional service software application 114 will deduct amounts from the employee compensation as required by applicable law, including deductions for federal and state income tax withholding, the Federal Insurance Corporation Act (FICA) tax, and Medicare withholding as applicable by Law, The method and system of the invention also provides W2's at the end of each calendar year to all temporary and temp-, perm employees. Upon a temporary or temp-perm employee completing his/her assignment the employee will be automatically placed back into the applicant pool as non-paid status until such time the employee accepts another paid assignment or deactivates their profile. A buyout option is available for temporary and temp-perm employees at any time. An employee must work 520 hours on JOBDOGGs' payroll prior to being converted or bought out. If the employee has not met the mandatory 520 hours on “JOBDOGG's” payroll, a conversion or buy out fee is charged and is calculated on the remaining hours to be worked. A built-in calculation on the system accomplishes this function. There is never a cost to a potential candidate or employees of “JOBDOGG”. Employers pay an annual membership fee and a mark-up rate on top of the employees' hourly rate. If an employer hires a permanent or direct hire the membership fee applies as well as a one-time fee/percentage on the candidate's annual salary.

If the employee is in their confidential personal profile, they will have a link to complete their timecard weekly to be approved by direct/authorized department head. The employee has the ability to enter log time daily. Upon completion of weekly assignment employee will electronically sign timecard agreeing to the true, correct and accuracy of timecard (Terms and use agreement inserted). The employee will then hit “submit” so that the timecard will be submitted to the employer (direct department/authorized department head/supervisor). When the employee registers/completes initial profile (first time user), the employee has the option to choose to have their pay direct deposited, paid on the transactional service pay card (“JOBDOGG” Paycard) or have checked mailed. The pay period runs from Sunday-Saturday 12 midnight. The employee portal tool will also have the ability to receive W-2's annually, and ability to print timecards, etc. The temporary and temp-perm employees have W-2's at the end of the year and W-4 and I-9 info is captured upon registration. If timecard is not completed by Saturday midnight, the employee will be paid following week. Also, the employee will also be notified of all incidentals, i.e. Uber, Lyft and/or DoggPOUND™ Transporters, and any other incidentals incurred. Upon the employee clicking the submit button an alert will be sent to the employer notifying to approve the timecard. Upon the employer approving the timecard, the employee will be notified via employee personal email, employee portal and SMS text message of a successful approval. Upon submission and approved edits can no longer be made. The timecard should automatically calculate Reg. hrs./OT hrs., Taxes (for ea. State) based on initial profile information when employee entered/completed W-4 etc. The W-4 should be on the timecard page to be completed upon receiving the first assignment to the employee. The employee should have the option to make changes to their W-4.

The transactional service software application 114 creates a technological platform that allows employee candidates to be matched with potential employers at the click of a button. The employee candidates are already prescreened with background checks, reference checks, and skill-set tested as well as skill-certified via online training and assessment. The transactional service software application 114 enables a platform of already vetted candidates with backgrounds, skills-sets, and references already completed through a third party vendor. E-Verification and W-4s' are also completed for all temporary and temp-perm employees, these temporary employees and temp-perm employees are “JOBDOGG's” employees. The prequalification along with each candidate's video presentation allows employers to input assignments and have a competent candidate selected as an immediate match and hired instantaneously. All of the users, both employers and employees, will be notified of the selection and acceptance instantaneously. The transactional service software application 114 is enabled to combine the services of physical traditional brick and mortar staffing agencies and Internet job boards/resume posting websites. The system allows instantaneous hires with desired pay. The transactional service software application 114 revolutionizes the staffing industry by merging traditional physical staffing services with social media, resume/job posting boards, payroll services, background check services and vendor management services on one web-site, saving its users substantially on their bottom line. The benefits of using the transactional service software application 114 include a wide range of services available to employers and employees and also permanent job offers can be made. A targeted query system assists employers as they discover a vast, diverse pool of pre-screened employee candidates with background checks, drug testing, skill-set testing and references already completed. Employers can view profiles of each employee candidate, using a proprietary rating system, and be greeted by a 3-5 minute live video presentation, highlighting the potential employee's qualifications, experience, and accomplishments. The employees have a competitive edge over the competition, namely because the personal profile and video presentation of the employee provides a complete picture of who they are and what they have to offer. The transactional service software application 114 is a singular source for all employment needs, cutting out the middlemen and the significant amount of fees that are associated to utilize these now separate venues that perform identical functions. The transactional service software application 114 is subscription based, employers will be able to save on their staffing budgets and have the comfort of utilizing one solution without the hassle of contacting multiple resources. With a click of a button, the company can hire and pay on-line. The employer has the option of paying via an established account set-up, ACH wire transfer/bank draft, or Visa/MC payment directly on-line. The employer can hire at a moment's notice to have the employee show-up for work immediately. The employee can be alerted by email and/or SMS text messaging of temporary and temp-perm job assignments and permanent full-time opportunities that meet their specific skill-sets and job requirements and can be dispatched out to the physical job assignment utilizing a provided map. The employee has the ability to record their working hours on-line and receive their pay on-line via direct deposit, Visa/MC pay-card or a paper check mailed. The transactional service software application 114 can effectively and efficiently accomplish the duties of a staffing agency on-line, 24 hours, 7 days a week, with a click of a button. The transactional service software application 114 has an array of resources at the user's fingertips, including profile input with video upload, job searching and job placement, company information search, on-line interviews in real-time, computer training and testing, on-line job related resources, resume writing services, interviewing tips, educational resources/tools, and health care coverage with access 24 hours 7 days a week. Back-end administrators closely monitor all confidential and proprietary information 24 hours 7 days a week to include proper candidate profile public release. The job assignments and job offers for all skill-sets, backgrounds, age groups and industries are available in the system. There are no pass or fail on skill-sets or backgrounds, the decision on selection and hiring is strictly up to the user/employer on whom they desire to hire. “JOBDOGG” disclaims we have done our due diligence in the pre-screen/vetting process by using and partnering with our 3^{rd} party vendors.

The examples of the invention described herein provide the transactional service system 104 for enabling transactional services between multiple independent parties in which one or more transactions involving the recruitment, hiring, employment and retention of workers by an employer directly with an employee or with an intermediary agent are executed. It is contemplated that all matters relating to the employment, such as compensation, timing, travel arrangements, training, development and human resource services, may be facilitated by systems and methods of the invention. For example, a user profile may be created and updated based on activities involving the features of the invention, such as jobs performed, performance reviews or ratings, job skills attained, training completed, availability, etc. The user profile may also include information which may typically be included in a resume and may also include images and video provided by the user.

The transactional service system 104 may be configured to receive input through the user interface which is provided on the at least one communication device 102. The input may be from the user who has signed up or otherwise created an account with the proprietor of the system of the invention. The user may include employers and employees, potential candidates for work assignments and employment by either one or both of an employer or intermediary agent. The input may relate to one or more available assignments, work opportunities and candidate availability and background information, such as relevant skills and training, among other things. The input data may also trigger queries from the system of the invention. Input information is stored in the database 118 and made available for searching by both employers seeking candidates for temporary, temp-to perm or permanent employment; and employees or candidates seeking temporary, temp-to perm or permanent employment.

The input data is received and analyzed by the transactional service system 104 which may then communicate with one or more other parties, the other parties having also signed up to the system to receive such communications, regarding potential candidates that meet hiring criteria or potential employers which meet the interests specified by users seeking work.

In some embodiments, the transactional service system 104 selects the one or more potential transacting parties based on a determination that these one or more parties are the most likely to be willing to execute the transaction. In some embodiments, a hierarchy of other parties is formed and communication regarding the transaction is sent to one party at a time, wherein each party is given a preset time to either agree to execute the transaction or pass on the transaction. Once either of the parties pass on executing the transaction, that party is removed and a new party from the hierarchy will replace the removed party. The selection process may include a determination of the most likely party to be able to execute the transaction, with the determination process being based on the inputted data, such as the years of experience and rating, type of employment sought and location, or other logistics, such as whether the work assignment requires travel or physical activity.

Upon parties agreeing to execute a transaction, further communications may be sent between the transacting parties. For example, notifications may be sent to a hired worker regarding their commute, required employer rules and procedures and as reminders of timing. Upon the execution of a transaction, the transactional service system 104 may automatically deduct and then credit funds between the transacting parties. In some embodiments, the transactional service system 104 may confirm that users have sufficient funds to provide payment, or otherwise connect with a user bank account or credit card for either one or both of withdrawing funds and making payment with such funds.

One or more embodiments described herein provide that methods, techniques, and actions performed by the at least one communication device 102 are performed programmatically, or as a computer-implemented method. Programmatically, as used herein, means through the use of code or computer-executable instructions. These instructions can be stored in one or more memory resources of the computing device. A programmatically performed step may or may not be automatic. One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

The at least one communication device 102 is selected from a group consisting of: a cellular telephone, a smartphone, a wireless-enabled personal digital assistant, a tablet, a personal computer, a notebook and a mobile device. The network 108 is a data communication network selected from a group consisting of: Internet, a local area network (LAN), a wide area network (WAN), wired Ethernet, wireless Ethernet and cellular wireless network. Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

One or more embodiments described herein may be implemented through the use of instructions that are executable by one or more processors 112. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) 112 and various forms of memory unit 116 for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

In some embodiments, the methods, systems, and media disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages. The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In certain other embodiments, a computer program includes, in part or in whole, one or more web applications, one or more mobile applications, one or more standalone applications, one or more web browser plug-ins, extensions, add-ins, or add-ons, or combinations thereof.

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® Actionscript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®.

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein. In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof. Suitable mobile application development environments are available from several sources. In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands. In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

In some embodiments, the methods, systems, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the methods, systems, and media disclosed herein include one or more databases, or use of the same. In view of the disclosure provided herein, those of skill in the art will recognize that many databases are suitable for storage and retrieval user profile and geolocation information. In various embodiments, suitable databases include, by way of non-limiting examples, relational databases, non-relational databases, object-oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

The at least one communication device 102 upon which embodiments described herein may be implemented may include a server or combination of servers, i.e., transactional service server 110. For example, the at least one communication device 102 may be implemented as part of the network service 108 for arranging transactions as described herein, that is, recruiting and hiring services, or as a component of a more general transactional service system 104. The processor 112 is configured with the transactional service application 114 and/or other logic to perform one or more processes, steps and other functions described herein.

In one implementation, the computer system includes processing resources, a main memory unit 116, a read-only memory (ROM), a data storage device, and a communication interface. The computer system includes at least one processor 112 for processing information stored in the main memory unit 116, such as provided by a random access memory (RAM) or other dynamic storage device, for storing information and instructions which are executable by the processor 112. The main memory 116 may also be used for storing temporary variables or other intermediate information during execution of instructions to be executed by the processor 112. The computer system may also include ROM or other static storage device for storing static information and instructions for the processor 112. A storage device, such as a magnetic disk or optical disk, is provided for storing information and instructions. The communication interface enables the computer system to communicate with one or more networks 108 (e.g., cellular network) through use of the network link (wireless or a wire). Using the network link, the computer system can communicate with one or more computing devices, and one or more servers. The executable instructions stored in the memory, the ROM, and/or the storage device can include determination instructions for determining the party most likely to engage in the transaction and service pricing instructions.

Examples described herein are related to the use of the computer system for implementing the techniques described herein. According to one embodiment, those techniques are performed by the computer system in response to the processor 112 executing one or more sequences of one or more instructions contained in the main memory unit 116. Such instructions may be read into the main memory unit 116 from another machine-readable medium, such as the storage device. Execution of the sequences of instructions contained in the main memory unit 116 causes the processor 112 to perform the process steps described herein (e.g., determine the most likely transacting party and service price). In alternative implementations, hard-wired circuitry may be used in place of or in combination with software instructions to implement examples described herein. Thus, the examples described are not limited to any specific combination of hardware circuitry and software.

The systems and methods of the invention may also be implemented on a mobile computing device which corresponds to, for example, a cellular communication device (e.g., feature phone, smartphone etc.) that is capable of telephony, messaging, and/or data services. In variations, the mobile computing device can correspond to, for example, a tablet or wearable computing device. Still further, the mobile computing device can be distributed amongst multiple portable devices of a transacting party. The mobile computing device includes a processor, memory resources, a display device (e.g., such as a touch-sensitive display device), one or more communication sub-systems (including wireless communication sub-systems), input mechanisms (e.g., an input mechanism can include or be part of the touch-sensitive display device), and one or more location detection mechanisms (e.g., GPS component). In one example, at least one of the communication sub-systems sends and receives cellular data over data channels and voice channels. The memory resources can store one or more applications (service application) for linking the mobile computing device with a network service that enables or otherwise facilitates trucking service transactions of the invention, for example. The mobile computing device can receive input relating to a trucking service request from a network service via one of the communication subsystems (e.g., cellular interface). The processor can display the logistics and price for one or more potential trucking service providers to consider and respond to for purposes of fulfilling the trucking service request.

The present invention may be embodied within a system, a method, a computer program product or any combination thereof. The computer program product may include a computer readable storage medium or media having computer readable program instructions thereon for causing a processor 112 to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Those skilled in the art will appreciate that the types of software and hardware used are not vital to the full implementation of the methods of the invention. The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

While exemplary systems and methods, and applications of methods of the invention, have been described herein, it should also be understood that the foregoing and appended documents are only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth herein and in the appended documents, as well as equivalents thereto.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A system for enabling at least one transactional service between a plurality of transacting parties, the system comprising:
at least one communication device;
a user interface, configured to the at least one communication device, for receiving a plurality of user inputs that initiates the at least one transactional service; and
a transactional service system being in communication with the at least one communication device via a network, the transactional service system including a transactional service server residing on a central computer having a processor installed with a transactional service application and coupled with a memory unit integrated with a central database, the transactional service application comprising a plurality of programmatic module, the programmatic module further comprising:
a registration module, at the processor, configured to enable a user to register in the transactional service application utilizing the at least one communication device;
an identification module, at the processor, configured to identify if the user is an employee or an employer;
a welcome module, at the processor, configured to enable the user to create a user profile by providing the plurality of user inputs;
an analyzing module, at the processor, configured to allow the user to analyze the plurality of user inputs stored in the central database of the transactional service system, the analyzing module comprising:
a recruitment management module, at the processor, configured to design and manage at least one recruiting process by the employer through the at least one communication device;
a hiring establishment module, at the processor, configured to evaluate and integrate at least one hire by the employer and the employee;
an employment module, at the processor, configured to maintain a plurality of employment activities by the employer and the employee; and
a retention determination module, at the processor, configured to monitor performance rating by the employer and the employee through the at least one communication device;
a timecard module, at the processor, configured to allow the employee to maintain a timecard to reflect an accurate number of working hours and also configured to allow an employer/authorized department head to review and approve or reject the employee timecard;
a reporting module, at the processor, configured to allow the employer to view, download and print their hiring and staffing trends along with statistical data and information on current and past employees that are in the system database;
a user authorization module, at the processor, configured to authorize the user whether to execute the at least one transactional service or pass on the at least one transactional service; and
a notification/alert sending module, at the processor, configured to electronically send a notification upon a successful execution of the at least one transactional service.

2. The system of claim 1 wherein the at least one communication device is selected from a group consisting of: a cellular telephone, a smartphone, a wireless-enabled personal digital assistant, a tablet, a personal computer, a notebook and a mobile device.

3. The system of claim 1 wherein the network is a data communication network selected from a group consisting of: the Internet, a local area network (LAN), a wide area network (WAN), wired Ethernet, wireless Ethernet and cellular wireless network.

4. The system of claim 1 wherein the plurality of programmatic module includes a program, a sub-routine, a portion of a program, or a software component or a hardware component capable of performing at least one programmatic task.

5. The system of claim 1 wherein the programmatic module further comprises a compensation establishment module, a travel arrangement module, a training module and a development module.

6. The system of claim 1 wherein the plurality of user inputs comprises at least one assignment, at least one work opportunity, at least one candidate availability and at least one background information and skillsets.

7. A method for enabling at least one transactional service between a plurality of transacting parties using a non-transitory computer program product being embodied in a computer readable medium, the method comprising the steps of:
a) enabling a user to register in a transactional service software application utilizing a registration module through at least one communication device;
b) identifying the user as an employee or an employer utilizing an identification module;
c) allowing the user to create a user profile by providing a plurality of user inputs utilizing a welcome module;
d) allowing the employer to design and manage at least one recruiting process utilizing a recruitment management module;
e) allowing the employer to integrate at least one hire by a hiring establishment module;
f) allowing the employee to maintain a plurality of employment activities utilizing an employment module;
g) allowing the employee to maintain a timecard to reflect an accurate number of working hours utilizing a timecard module;
h) allowing the employee to get approval electronically from an employer/authorized department head on submitting the timecard weekly and being paid on time;
i) allowing the employer to authorize, approve or reject timecard;
j) authorizing the user whether to execute at least one transactional service or pass on the at least one transactional service, utilizing a user authorization module;
k) allowing the user to receive notification on a successful execution of the at least one transactional service, utilizing a notification/alert sending module; and
l) allowing the employer to have data and statistical information on their staffing/hiring trends in a snapshot and/or full detail view utilizing a report/business analytics module.

8. The method of claim 7 wherein the at least one communication device is selected from a group consisting of: a cellular telephone, a smartphone, a wireless-enabled personal digital assistant, a tablet, a personal computer, a notebook and a mobile device.

9. The method of claim 7 wherein the network is a data communication network selected from a group consisting of: the Internet, a local area network (LAN), a wide area network (WAN), wired Ethernet, wireless Ethernet and cellular wireless network.

10. The method of claim 7 wherein the programmatic module further comprising a compensation establishment module, a travel arrangement module, a training module and a development module.

11. A non-transitory computer-readable medium having a plurality of computer-readable program instructions embodied therein which when executed by a computer having a processor installed with a transactional service software application and coupled with a memory unit integrated with a central database causes the processor to perform the following steps:
a) enabling a user to register in the transactional service software application utilizing a registration module through at least one communication device;
b) greeting the user by creating an animation including an artificial intelligence analytic;
c) identifying the user as an employee or an employer utilizing an identification module; wherein
for the employee, the plurality of program instructions being further executable by the processor to cause the following operations:
I) allowing the employee to create a personal profile by providing a plurality of personal information utilizing a welcome module;
i) pre-screening the employee with at least one background check, at least one reference check and at least one drug test;
ii) verifying prequalification of the employee by testing at least one skill-set and at least one skill-certification;
iii) uploading a video presentation of the employee highlighting at least one employment background, at least one professional experience, at least one talent and at least one accomplishment; and
iv) providing an on-line payment option via direct deposit, and/or an electronic payment card or paper check; and
v) selecting a rideshare mode by the employee;
for the employer, the plurality of program instructions being further executable by the processor to cause the following operations:
I) allowing the employer to create a company profile by providing a plurality of company information utilizing the welcome module;
i) providing a brand advertising and a banner advertising combined with an option to create a corporate video and at least one job requisition/posting; and
ii) providing the online payment option via an established account set-up, ACH wire transfer, bank draft, or an electronic pay card;
d) allowing the user to analyze a plurality of user inputs stored in a central database of the transactional service application utilizing an analyzing module; wherein
for the employee, the plurality of program instructions being further executable by the processor to cause the following operations:
i) allowing the employee to search for at least one temporary, temp to perm or permanent assignment;
ii) accessing the at least one job posted by the employer;
iii) greeting the employer with a video presentation;
iv) receiving an alert of the at least one temporary, temp to perm or permanent assignment by email and/or SMS text message;
v) accepting the at least one temporary, temp to perm or permanent assignment posted by the employer;
vi) agreeing to the rate of pay detailed in the at least one job requisition/posting;
vii) dispatching out to the at least one job assignment utilizing a location map and show-up to work instructions via email and SMS text message;
viii) recording a daily attendance time sheet, clock in and clock out events including a Global Positioning System (GPS) location data; and
ix) receiving the payment on-line via the direct deposit the electronic pay-card or paper check;
for the employer, the plurality of program instructions being further executable by the processor to cause the following operations:
i) allowing the employer to post a job requisition for the at least one temporary, temp to perm or permanent assignment;
ii) providing the brand advertising of the employer including an option to create the corporate video and department video;
iii) creating a job requisition for temporary, temp to perm or permanent employee hire depending on the assignment;
iv) viewing the personal profile on the proprietary spinning carousel of at least one potential employee and arranging a plurality of virtual interviews and/or immediate hire;
v) hiring the at least one potential employee at a moment's notice; and
vi) sending alert to the potential employee on the at least one temporary, temp to perm or permanent assignment by email and/or SMS text message;
e) tracking, editing and electronically approving the employee timecard to reflect an accurate number of working hours, the timecard being enabled to automatically calculate Reg. hrs./OT hrs., DT hours and holiday hours utilizing a timecard module;
f) allowing the employer to have data and statistical information in a snapshot or detailed full view of their staffing/hiring trends utilizing the report business analytics module;
g) authorizing the user whether to execute at least one transactional service or pass on the at least one transactional service, utilizing a user authorization module; and
h) receiving notification on a successful execution of the at least one transactional service, utilizing a notification sending module.

12. The non-transitory computer-readable medium of claim 11 wherein the at least one communication device is selected from a group consisting of: a cellular telephone, a smartphone, a wireless-enabled personal digital assistant, a tablet, a personal computer, a notebook and a mobile device.

13. The non-transitory computer-readable medium of claim 11 wherein the network is a data communication network selected from a group consisting of: the Internet, a local area network (LAN), a wide area network (WAN), wired Ethernet, wireless Ethernet and cellular wireless network.

14. The non-transitory computer-readable medium of claim 11 wherein the video presentation of the employee is enabled through a proprietary rated profile system and proprietary spinning carousel.

15. The non-transitory computer-readable medium of claim 11 wherein the employee can search for the at least one job assignment utilizing a proprietary targeted query search optimization.
